(19) United States
(12) Patent Application Publication
(10) Pub. No.: US 2025/0069276 A1
(43) Pub. Date: Feb. 27, 2025

(54) VIDEO PROCESSING METHOD AND ELECTRONIC DEVICE

(71) Applicant: ZHEJIANG DAHUA TECHNOLOGY CO., LTD., HANGZHOU (CN)

(72) Inventors: Shuang PENG, HANGZHOU (CN); Jucai LIN, HANGZHOU (CN); Dong JIANG, HANGZHOU (CN); Cheng FANG, HANGZHOU (CN); Jun YIN, HANGZHOU (CN)

(73) Assignee: ZHEJIANG DAHUA TECHNOLOGY CO., LTD., HANGZHOU (CN)

(21) Appl. No.: 18/914,071

(22) Filed: Oct. 12, 2024

Related U.S. Application Data
(63) Continuation of application No. PCT/CN2023/087680, filed on Apr. 11, 2023.

(30) Foreign Application Priority Data
Apr. 12, 2022 (CN) 202210384168.1
May 31, 2022 (CN) 202210612267.0

(51) Int. Cl. G06T 9/00; G06T 3/4046; G06T 3/4053

(52) U.S. Cl. CPC G06T 9/002; G06T 3/4046; G06T 3/4053

(57) ABSTRACT

A video processing method and an electronic device are provided. The method includes: obtaining a to-be-processed video sequence; resampling at least one picture of the to-be-processed video sequence, and encoding the at least one picture based on a quantization parameter after resampling; the quantization parameter after resampling is obtained by offsetting a quantization parameter before resampling based on an offset value of quantization parameters of the to-be-processed video sequence, and each resampled picture is encoded to obtain an encoded picture; and performing a picture resolution reconstruction on the encoded picture as an input picture to generate an output picture; the output picture has a resolution higher than a resolution of the input picture.

### CROSS REFERENCE TO RELATED APPLICATIONS

The present disclosure is a continuation of International Patent Application No. PCT/CN2023/087680, filed Apr. 11, 2023, which claims priority to Chinese Patent Applications No. 202210384168.1, filed Apr. 12, 2022, and No. 202210612267.0, filed May 31, 2022, both of which are herein incorporated by reference in their entireties.

### TECHNICAL FIELD

The present disclosure relates to the field of picture processing technologies, and in particular to a video processing method and an electronic device.

### BACKGROUND

In order to improve transmission speed and adapt to transmission conditions, it is often necessary to enable a technique employing reference picture resampling (RPR) in the video codec process, where the technique employing RPR is to down-sample an original-sized picture with high resolution into a small picture with low resolution before encoding and transmission, and to up-sample the reconstructed small picture into the original-sized picture at the decoding end, thereby saving the bit consumption of encoding in case of poor transmission conditions or improving the encoding efficiency, etc.

However, enabling resampling techniques in the video codec process may cause video distortion.

The amount of video picture data is relatively large, and it is usually necessary to compress video pixel data to form a video code stream, which is transmitted through wired or wireless network to a user side and decoded for user viewing. After reconstructing the pixels of the picture, the resolution of the picture is lower. For this reason, reconstruction of lower resolution pictures to higher resolutions is one of the important needs in the field of picture processing, for extracting enough information. Currently, the existing super-resolution reconstruction techniques are not designed properly, which easily leads to low quality after the picture reconstruction.

### SUMMARY OF THE DISCLOSURE

In a first aspect, the present disclosure provides a video processing method, including: obtaining a to-be-processed video sequence; resampling at least one picture of the to-be-processed video sequence, and encoding the at least one picture based on a quantization parameter after resampling; the quantization parameter after resampling is obtained by offsetting a quantization parameter before resampling based on an offset value of quantization parameters of the to-be-processed video sequence, and each resampled picture is encoded to obtain an encoded picture; and performing a picture resolution reconstruction on the encoded picture as an input picture to generate an output picture; the output picture has a resolution higher than a resolution of the input picture.

In a second aspect, the present disclosure provides a video decoding method, including: obtaining a to-be-decoded picture; decoding the to-be-decoded picture to obtain a decoded picture; and performing a picture resolution reconstruction on the decoded picture to generate an output picture. The output picture has a resolution higher than a resolution of the decoded picture.

In a third aspect, the present disclosure provides an electronic device including a processor and a memory connected to the processor; the memory stores a program instruction; the processor is configured to execute the program instruction stored in the memory to perform the method as above.

### BRIEF DESCRIPTION OF THE DRAWINGS

FIG. 1 is a flowchart of a video codec method according to an embodiment of the present disclosure.

FIG. 2 is a flowchart of S12 in FIG. 1.

FIG. 3 is a flowchart of a video codec method according to another embodiment of the present disclosure.

FIG. 4 is a flowchart of a video codec method according to further another embodiment of the present disclosure.

FIG. 5 is a flowchart of a video codec method according to still another embodiment of the present disclosure.

FIG. 6 is a flowchart of a video codec method according to still another embodiment of the present disclosure.

FIG. 7 is a structural schematic view of an electronic device according to an embodiment of the present disclosure.

FIG. 8 is a structural schematic view of a computer-readable storage medium according to an embodiment of the present disclosure.

FIG. 9 is a flowchart of a picture reconstruction method according to an embodiment of the present disclosure.

FIG. 10 is a structural schematic view of a super-resolution reconstruction network according to an embodiment of the present disclosure.

FIG. 11 is a structural schematic view of a convolutional neural network according to an embodiment of the present disclosure.

FIG. 12 is a structural schematic view of a 4*4 neighborhood of a to-be-interpolated pixel point according to an embodiment of the present disclosure.

FIG. 13 is a structural schematic view of a first attention layer according to an embodiment of the present disclosure.

FIG. 14 is a structural schematic view of a residual neural network according to an embodiment of the present disclosure.

FIG. 15 is a structural schematic view of a residual neural network according to another embodiment of the present disclosure.

FIG. 16 is a structural schematic view of a residual neural network according to further another embodiment of the present disclosure.

FIG. 17 is a structural schematic view of a first residual layer according to an embodiment of the present disclosure.

FIG. 18 is a structural schematic view of a second attention layer according to an embodiment of the present disclosure.

FIG. 19 is a structural schematic view of a mapping layer according to an embodiment of the present disclosure.

FIG. 20 is a structural schematic view of a second residual layer according to an embodiment of the present disclosure.

FIG. 21 is a structural schematic view of a third residual layer according to an embodiment of the present disclosure.

FIG. 22 is a structural schematic view of a fourth residual layer according to an embodiment of the present disclosure.

FIG. 23 is a flowchart of a picture encoding method according to an embodiment of the present disclosure.

FIG. 24 is a structural schematic view of an encoder according to an embodiment of the present disclosure.

FIG. 25 is a flowchart of a picture decoding method according to an embodiment of the present disclosure.

FIG. 26 is a flowchart of a picture decoding method in the related art.

FIG. 27 is a flowchart of a picture decoding method according to another embodiment of the present disclosure.

FIG. 28 is a flowchart of a picture decoding method according to further another embodiment of the present disclosure.

FIG. 29 is a structural schematic view of a decoder according to an embodiment of the present disclosure.

FIG. 30 is a structural schematic view of a computer-readable storage medium according to an embodiment of the present disclosure.

### DETAILED DESCRIPTION

The technical solutions in the embodiments of the present disclosure will be clearly and completely described below in conjunction with the accompanying drawings in the embodiments of the present disclosure, and it is clear that the described embodiments are only a part of the embodiments of the present disclosure, and not all of them. Based on the embodiments in the present disclosure, all other embodiments obtained by those skilled in the art without making creative labor fall within the scope of the present disclosure.

The terms “first”, “second”, and “third” in the present disclosure are used for descriptive purposes only and are not to be construed as indicating or implying relative importance or implicitly specifying the number of indicated technical features. Thus, a feature qualified with “first,” “second,” or “third” may explicitly or implicitly include at least one such feature. In the description of the present disclosure, “plurality” means at least two, e.g., two, three, etc., unless otherwise expressly and specifically limited.

References herein to “embodiments” mean that a particular feature, structure, or characteristic described in conjunction with an embodiment may be included in at least one embodiment of the present disclosure. The presence of the phrase at various points in the specification does not necessarily mean the same embodiment, nor is it a separate or alternative embodiment that is mutually exclusive with other embodiments. It is understood, both explicitly and implicitly, by those skilled in the art that the embodiments described herein may be combined with other embodiments without conflict.

Before introducing the video codec method of the present disclosure, an explanation of relevant terms is provided.

Codec: The picture data amount of a video sequence is relatively large, and it is necessary to encode the picture pixel data to obtain a video code stream, which is transmitted to a decoding end through wired or wireless network and then decoded for viewing. The whole codec process includes block division, prediction, transformation, quantization, coding, and other processes.

Quantization parameter (QP): QP characterizes the distortion of the video sequence due to quantization, usually the greater the QP, the higher the distortion due to quantization, and vice versa.

Rate, also known as bit rate: Rate is the number of bits transmitted per second. The greater the rate, the lower the distortion and the higher the quality of the picture, and the greater the bandwidth required. The less the rate, the higher the distortion and lower the quality of the picture, i.e., the rate is inversely correlated with the QP.

Reference picture resampling (RPR): RPR is to down-sample the original-sized picture into a small picture before encoding and transmission, and to up-sample the decoded and reconstructed small picture into the original-sized picture at the decoding end, so as to save the bit consumption of encoding under poor transmission conditions, or to improve the encoding efficiency, etc. The technique is also referred to as resampling later in the present disclosure.

Scaling ratio: In terms of scaling down and scaling up, the scaling ratio includes a reduced scale and a magnified scale, with the reduced scale being the scale at which down-sampling is performed in the resampling process and the magnified scale being the scale at which up-sampling is performed in the resampling process. From the perspective of scaling direction, the scaling ratio includes a horizontal scale and a vertical scale, with the horizontal scale being the ratio of the space resolution of the scaled picture to the original-sized picture in the horizontal direction, and the vertical scale being the ratio of the space resolution of the scaled picture to the original-sized picture in the vertical direction. The horizontal scale and the vertical scale may be the same or different. The scaling ratio is also referred to as the resampling ratio later in the present disclosure.

Peak signal to noise ratio (PSNR): PSNR is an index to evaluate the picture quality, usually the greater the value the higher the picture quality, and the less the value the worse the picture quality.

Video sequence: A sequence is a collection of pictures consisting of several temporally consecutive pictures, and can be further divided into at least one group of pictures (GOP), each GOP containing at least one consecutive picture, and each picture is also called a frame.

In the present disclosure, a video processing method is provided, including: obtaining a to-be-processed video sequence; (I): resampling at least one picture of the to-be-processed video sequence, where each resampled picture is encoded to obtain an encoded picture; and (II): performing a picture resolution reconstruction on the encoded picture as an input picture to generate an output picture; wherein the output picture has a resolution higher than a resolution of the input picture.

The step (I) will be described in detail in Implementation I, and the step (II) in Implementation II.

### Implementation I

FIG. 1 is a flowchart of a video codec method according to an embodiment of the present disclosure. It is to be noted that the present embodiment is not limited to the flow sequence shown in FIG. 1 when substantially the same results can be realized. The method may include operations at blocks illustrated in FIG. 1.

At block S11: obtaining a to-be-processed video sequence.

The to-be-processed video sequence includes at least one representative picture.

The to-be-processed video sequence may include multiple groups of pictures (GOP), and a GOP includes multiple pictures. A representative picture serves as a basis for resampling at least one picture of the to-be-processed video sequence.

At block S12: obtaining an offset value of quantization parameters of the to-be-processed video sequence before and after resampling.

The offset value of quantization parameters may cause that a first constraint relationship is satisfied between the rate-quantization balance cost of the representative picture before resampling and the rate-quantization balance cost of the representative picture after resampling. The rate-quantization balance cost before resampling is obtained by fusing the rate and quantization parameter before resampling, and the rate-quantization balance cost after resampling is obtained by fusing the desired rate and quantization parameter after resampling.

The rate and quantization parameter (QP) are inversely correlated. Satisfying the first constraint relationship means that the offset value of quantization parameters is in the expectation, the subsequent quantization parameter after resampling obtained based on the offset value of quantization parameters is also in the expectation, and the balance between the rate and quantization parameter before and after resampling is in the expectation. In this way, resampling does not lead to an imbalance between the rate and quantization parameters.

The first constraint relationship may be a functional relationship (linear function, nonlinear function), mapping table, etc. For example, the first constraint relationship is that a proportional relationship is satisfied between the rate-quantization balance cost before resampling and the rate-quantization balance cost after resampling. That is, the first constraint relationship is as follows.

$${keep}_{1} = S \cdot {keep}_{0} \qquad ( 1 )$$

$${keep}_{0} = {f}_{0} ( {qp}_{0} , {rate}_{0} ) \qquad ( 2 )$$

$${keep}_{1} = {f}_{1} ( {qp}_{1} , {rate}_{1} ) \qquad ( 3 )$$

Where keep₀ denotes the rate-quantization balance cost before resampling; keep₁ denotes the rate-quantization balance cost after resampling; S denotes a third factor, i.e., a cost compensation factor after resampling; rate₀ and qp₀ denote the rate and quantization parameters before resampling, respectively; rate₁ and qp₁ denote the expected rate and quantization parameters after resampling, respectively.

The way of fusing the rate and quantization parameters to obtain the rate-quantization balance cost may be weighting, multiplying, etc.

In some embodiments, multiple candidate offset values of quantization parameters may be set in advance in S12, and each candidate offset value of quantization parameters may be tested one by one whether it can cause the first constraint relationship between the rate-quantization balance cost of the representative picture before and after resampling to be satisfied, and the candidate offset value of quantization parameters that causes the first constraint relationship between the rate-quantization balance cost of the representative picture before and after resampling to be satisfied will be taken as the final offset value of quantization parameters.

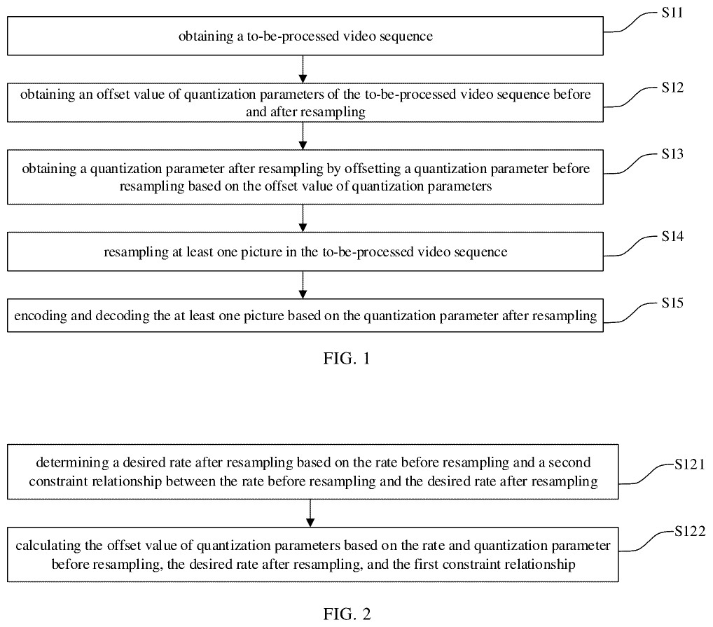

In other embodiments, the offset value of quantization parameters may be obtained in S12 based on the rate and the quantization parameter before resampling, a second constraint relationship between the rate before resampling and the desired rate after resampling, and the first constraint relationship. Based on this, with reference to FIG. 2, S12 may include the following sub-operations.

At block S121: determining a desired rate after resampling based on the rate before resampling and a second constraint relationship between the rate before resampling and the desired rate after resampling.

The second constraint relationship may be configured to constrain rate difference, rate ratio, rate difference ratio, etc. between the rate before resampling and the desired rate after resampling. The rate difference ratio is a ratio between the rate difference and the rate before resampling.

The subsequent coding and decoding of the to-be-processed video sequence at the desired rate after resampling does not result in an imbalance between the rate and quantization parameters. The determined desired rate after resampling may be a single value or a range of values. For example, the second constraint relationship is that a proportional range is satisfied between the rate before resampling and the desired rate after resampling, which can be expressed as follows.

$$\vert {rate}_{1} - {rate}_{0} \vert / {rate}_{0} \leq φ \qquad ( 4 )$$

The rate after resampling may be obtained by deforming Equation (4).

$$( 1 - φ ) \cdot {rate}_{0} \leq {rate}_{1} \leq ( 1 + φ ) \cdot {rate}_{0} \qquad ( 5 )$$

Therefore, the expected rate after resampling can be expressed as

$${rate}_{1} = k \cdot {rate}_{0} , k ∈ [ 1 - φ , 1 + φ ] \qquad ( 6 )$$

Where φ denotes a rate difference ratio threshold, |rate₁−rate₀|/rate₀ denotes the rate difference ratio, and k denotes a rate compensation factor after resampling.

At block S122: calculating the offset value of quantization parameters based on the rate and quantization parameter before resampling, the desired rate after resampling, and the first constraint relationship.

There is a first functional relationship between the rate-quantization balance cost before resampling and the rate and quantization parameter before resampling, and a second functional relationship between the rate-quantization balance cost after resampling and the desired rate and quantization parameter after resampling.

The first functional relationship/second functional relationship may be either linear or nonlinear.

The parameters in the first functional relationship include the rate-quantization balance cost before resampling, the rate and quantization parameter before resampling, and a first coefficient (the rate-quantization balance factor before resampling). The parameters in the second functional relationship include the rate-quantization balance cost after resampling, the expected rate and quantization parameter after resampling, and a second coefficient (the rate-quantization balance factor after resampling). The parameters in the first constraint relationship include the rate and quantization parameter before resampling, the desired rate and quantization parameter after resampling, and a third coefficient (the cost balance factor after resampling).

Based on above, the offset value of quantization parameters can be calculated based on the first functional relationship, the second functional relationship, and the first constraint relationship as follows.

$${qp}_{offset} = {qp}_{1} - {qp}_{0} = {f}_{offset} ( {qp}_{0} , {rate}_{0} , {λ}_{0} , {λ}_{1} , S ) \qquad ( 7 )$$

Where λ₀, λ₁, and S denote the first, second and third coefficients, respectively.

As an example, in the first functional relationship, the rate-quantization balance cost before resampling is a linear summation between the rate before resampling multiplied by the first coefficient and the quantization parameter before resampling. The first functional relationship can be expressed as follows.

$${keep}_{0} = {qp}_{0} + {λ}_{0} \cdot {rate}_{0} \qquad ( 8 )$$

In the second functional relationship, the rate-quantization balance cost after resampling is a linear summation between the desired rate after resampling multiplied by the second coefficient and the quantization parameter after resampling. The second functional relationship can be expressed as follows.

$${keep}_{1} = {qp}_{1} + {λ}_{1} \cdot {rate}_{1} \qquad ( 9 )$$

Bringing Equation (8) and Equation (9) into Equation (1) yields the following.

$${qp}_{1} + {λ}_{1} \cdot {rate}_{1} = S \cdot ( {qp}_{0} + {λ}_{0} \cdot {rate}_{0} ) \qquad ( 10 )$$

Deforming Equation (10) yields the following.

$${qp}_{offset} = {qp}_{1} - {qp}_{0} = ( S - 1 ) \cdot {qp}_{0} + S \cdot {λ}_{0} \cdot {rate}_{0} - {λ}_{1} \cdot {rate}_{1} \qquad ( 11 )$$

Further. λ₀, λ₁, and S may both be constants, such that λ₀, λ₁, and S may be directly brought into Equation (7)/Equation (11) for calculating to obtain the offset value of quantization parameters. Alternatively, at least one of the λ₀, λ₁, and S is a variable, and it is necessary to solve for the variable and then bring it into Equation (7)/Equation (11) to calculate the offset value of quantization parameters.

In the case that λ₀ and λ₁ are variables, it can be set that there is a third functional relationship between the rate and quantization parameter before resampling, and a fourth functional relationship between the desired rate and quantization parameter after resampling. The third function relationship/fourth function relationship may be a linear function relationship or a nonlinear function relationship. The third function relationship and the fourth function relationship may be obtained statistically from pairs of the rate and quantization parameter of historical pictures that have been coded and decoded.

For example, in the third functional relationship, the quantization parameter before resampling is a power function of the rate before resampling, and in the fourth functional relationship, the quantization parameter after resampling is a power function of the desired rate after resampling. As a result, the third functional relationship can be expressed as follows.

$${qp}_{0} = {f}_{0} ( {rate}_{0} ) = {α}_{0} \cdot {rate}_{0}^{{β}_{0}} \qquad ( 12 )$$

The fourth functional relationship can be expressed as follows.

$${qp}_{1} = {f}_{1} ( {rate}_{1} ) = {α}_{1} \cdot {rate}_{1}^{{β}_{1}} \qquad ( 13 )$$

Where α₀, β₀, α₁, and β₁ are constants, for example α₀=230, β₀=−0.23, α₁=235, and β₁=−0.26.

Therefore, the first coefficient of the first functional relationship can be calculated based on the third functional relationship, and the second coefficient of the second functional relationship can be calculated based on the fourth functional relationship; the offset value of quantization parameters can be calculated based on the first coefficient, the second coefficient, the rate and quantization parameter before resampling, the desired rate after resampling, and the first constraint relationship. In a specific embodiment, the absolute value of the partial derivative of the third functional relationship at the rate before resampling may be taken as the first coefficient, and the absolute value of the partial derivative of the fourth functional relationship at the desired rate after resampling may be taken as the second coefficient.

Examples of the acquisition of the offset value of quantization parameters based on Equations (8) to (10) and Equations (12) and (13) are given as follows.

For the solution of λ₀, the partial derivative of the equation is obtained as keep₀′ and let keep₀′=0, such that the following can be obtained.

$${λ}_{0} = - \frac{\partial {qp}_{0}}{\partial {rate}_{0}} = - {qp}_{{0}_{{rate}_{0}}}^{′} \qquad ( 14 )$$

It is known that 2% is the negative partial derivative of qp₀ with respect to rate₀. Since qp₀ is inversely proportional to rate₀ and qp₀ is a one-dimensional function with respect to rate₀, λ₀ is the absolute value of the derivative of qp₀ with respect to rate₀.

$${λ}_{0} = \vert {f}_{0}^{′} ( {rate}_{0} ) \vert = {α}_{0} \cdot {β}_{0} \cdot {rate}_{0}^{{β}_{0} - 1} \qquad ( 15 )$$

The same reasoning leads to.

$${λ}_{1} = \vert {f}_{1}^{′} ( {rate}_{1} ) \vert = {α}_{1} \cdot {β}_{1} \cdot {rate}_{1}^{{β}_{1} - 1} \qquad ( 16 )$$

Bringing Equation (15) and Equation (16) into Equation (11) yields the following.

$${qp}_{offset} = ( S - 1 ) \cdot {qp}_{0} + S \cdot \vert {f}_{0}^{′} ( {rate}_{0} ) \vert \cdot {rate}_{0} - \vert {f}_{1}^{′} ( rate 1 ) \vert \cdot {rate}_{1} \qquad ( 17 )$$

Further, when the desired rate after resampling is a single value, the offset value of quantization parameters obtained by the solution is a single value. When the desired rate after resampling is a range, the range of the offset value of quantization parameters can be determined based on the range of the desired rate after resampling; at least two candidate values are selected from the range of the offset value of quantization parameters and weighted and summed to be the offset value of quantization parameters. For example, the selected candidate values are the maximum and minimum values of the offset value of quantization parameters.

As an example, bringing Equation (6) into Equation (17) yields the following.

$${qp}_{offset} = ( S - 1 ) \cdot {qp}_{0} + ( \vert S \cdot {f}_{0}^{′} ( {rate}_{0} ) \vert - k \cdot \vert {f}_{1}^{′} ( k \cdot {rate}_{0} ) \vert ) \cdot {rate}_{0} \qquad ( 18 )$$

Substituting the values of α₀, β₀, α₁, and β₁ into Equation (18) yields the following.

$${qp}_{offset} = ( S - 1 ) \cdot {qp}_{0} + ( S \cdot 52.9 \cdot {rate}_{0}^{- 1.23} - k \cdot 61.1 \cdot {( k \cdot {rate}_{0} )}^{- 1.26} ) \cdot {rate}_{0} \qquad ( 19 )$$

Equation (19) allows to determine the maximum value qp_{max_offset} and the minimum value qp_{min_offset} of the offset value of quantization parameters. After weighting the two and then rounding, the final offset value of quantization parameters is obtained.

$${qp}_{offset} = round ( {ω}_{0} \cdot {qp}_{m i n \_ offset} + {ω}_{1} \cdot {qp}_{m ax \_ offset} ) \qquad ( 20 )$$

where round(⋅) denotes rounding to the nearest whole number, and ω₀ and ω₁ are weights of qp_{min_offset} and qp_{max_offset}, respectively.

In the above example, it may be set that S=0.95, φ=0.05, i.e., k∈[0.95, 1.05], and ω₀=ω₁=0.5. As a result, for the to-be-processed video sequence, Tango2, at qp₀=42 and rate₀=938 kbps, the obtained offset value of quantization parameters qp_{offset}=−2.

In other embodiments, S12 may include: obtaining the offset value of quantization parameters by looking up a table based on a difference characterization value between the rate before resampling and the actual rate after resampling.

The actual rate after resampling is the rate at which the picture is coded and decoded based on the quantization parameter before resampling after the picture is resampled. The difference characterization value may be rate difference value, rate ratio value, rate difference ratio, etc. For the calculation of the rate difference ratio, reference may be made to the previous description, which will not be repeated herein.

Multiple difference characterization value thresholds may be set in advance, and multiple difference characterization value ranges can be obtained based on the difference characterization value thresholds, and the difference characterization value ranges and the offset values of quantization parameters are stored in the mapping table in a one-to-one correspondence. In this way, it is possible to determine a difference characterization value range to which the difference characterization value belongs, and obtain the corresponding offset value of quantization parameters by looking up the table. The correspondence between the difference characterization value range and the offset value of quantization parameters may be obtained based on the statistics of the historical pictures that have been coded and decoded.

As an example, the difference characterization value is the rate difference ratio, the rate difference ratio thresholds include 75%, 50%, 25%, 10%, and 5%, and the pre-established mapping table is as follows.

| Rate difference ratio range | Offset value of quantization parameters |
|---|---|
| (0.50, 0.75] | −6 |
| (0.25, 0.50] | −5 |
| (0.10, 0.25] | −3 |
| (0.05, 0.10] | −2 |
| [0, 0.05] | −1 |

The rate difference ratio range to which the rate difference ratio between the rate before resampling and the actual rate after resampling belongs is determined, and the offset value of quantization parameters corresponding to the rate difference ratio range is obtained by looking up the table.

It can be understood that, on the one hand, compared with the way of testing each candidate offset value of quantization parameters one by one to obtain the offset value of quantization parameters, the difficulty of obtaining the offset value of quantization parameters can be reduced, and thus the codec complexity can be reduced. On the other hand, compared with the way to constrain the offset value of quantization parameters by the rate difference before and after resampling, the rate-quantization balance cost before and after resampling is used to constrain the offset value of quantization parameters in S12, which can avoid the problem of imbalance between the rate and quantization parameter brought by resampling.

At block S13: obtaining a quantization parameter after resampling by offsetting a quantization parameter before resampling based on the offset value of quantization parameters.

For example, the quantization parameter before resampling is 42, the offset value of quantization parameters is −2, and the quantization parameter after resampling is 40.

At block S14: resampling at least one picture in the to-be-processed video sequence.

The at least one picture is each a picture that is resampled based on the representative picture for decision making.

At block S15: encoding and decoding the at least one picture based on the quantization parameter after resampling.

In the codec process, the quantization parameter of the picture after resampling in the to-be-processed video sequence is the quantization parameter after resampling, while the quantization parameter corresponding to the picture without resampling is not changed, i.e., the quantization parameter of the picture without resampling is the quantization parameter before resampling.

It can be understood that enabling resampling techniques to resample pictures during the codec process may result in visual distortion of the video sequence. Specifically, if the pictures in the video sequence are resampled during the codec process, there may be an imbalance in the rate and quantization parameters of the pictures, making the quality of the pictures in the video sequence that have been resampled too low and the quality of the pictures that have been resampled and the pictures that have not been resampled discontinuous, resulting in visual distortion.

By the implementation of the embodiments of the present disclosure, in the case of resampling the pictures in the to-be-processed video sequence, the present disclosure obtains the quantization parameter after resampling based on the offset value of quantization parameters to offset the quantization parameter before resampling, and encodes and decodes the pictures that have undergone resampling based on the quantization parameter after resampling. The offset value of quantization parameters can cause the first constraint relationship between the rate-quantization balance cost of the representative picture before and after resampling to be satisfied, the rate-quantization balance cost before resampling is obtained by fusing the rate and quantization parameter before resampling, and the rate-quantization balance cost after resampling is obtained by fusing the desired rate and quantization parameter after resampling. Since the representative picture is used as the basis for resampling the picture in the to-be-processed video sequence, the first constraint relationship being satisfied implies that resampling a picture in the to-be-processed video sequence does not result in imbalance of the corresponding rate and quantization parameter of the picture. In this way, the codec method provided by the present disclosure may avoid the problem of imbalance of rate and quantization parameters brought about by resampling, and the quality of the picture that has been resampled will not be unduly degraded, thereby ensuring the continuity between the quality of the resampled pictures and the pictures that have not been resampled and avoiding the distortion of the video sequence brought about by resampling.

Further, the resampling-related steps (S12-S15) in the above embodiments may be preceded by a resampling decision to decide whether to resample the to-be-processed video sequence, and S12-S15 are executed when the decision to resample the to-be-processed video sequence is made. The above design may be implemented as follows.

FIG. 3 is a flowchart of a video codec method according to another embodiment of the present disclosure. It is to be noted that the present embodiment is not limited to the flow sequence shown in FIG. 3 when substantially the same results can be realized. The method may include operations, prior to S12, at blocks illustrated in FIG. 3.

At block S21: performing a resampling decision based on a quality characterization value of the representative picture after resampling at a resampling ratio.

The quality characterization value after resampling may be configured to evaluate the quality of the picture in a case where resampling is performed in the encoding process. The quality characterization value may be a rate representing the picture at the resampling ratio, a distortion (peak signal-to-noise ratio), or a rate-distortion balance cost. Of course, the quality characterization value may be other indexes to evaluate the picture quality.

Distortion can be obtained by converting the peak signal-to-noise ratio, and the rate-distortion balance cost can be obtained from the fusion of the actual rate and distortion of the representative picture after resampling at the resampling ratio. The fusion may be done by multiplication, weighting, etc. In the weighted approach, the rate-distortion balance cost is the weighted sum of the actual rate and distortion after resampling, which can be expressed as follows.

$$cost = d + μ \cdot {rate}_{1}^{′} \qquad ( 21 )$$

Where cost denotes the rate-distortion balance cost, d denotes the distortion degree, μ denotes the Lagrangian factor, and rate₁′ denotes the actual rate after resampling at resampling ratio.

The number of the resampling ratio is a single or at least two. When the resampling ratio is a single value, in S21, it may be determined whether the quality characterization value corresponding to the single resampling ratio is less than a characterization threshold; when the quality characterization value corresponding to the single resampling ratio is less than the characterization threshold, the decision is to perform resampling; when the quality characterization value corresponding to the single resampling ratio is greater than or equal to the characterization threshold, the decision is not to perform resampling. When the number of the resampling ratios is at least two, in S21, it may be determined whether the minimum value of the quality characterization values corresponding to the at least two resampling ratios is less than the characterization threshold; when the minimum value is less than the characterization threshold, the decision is to perform resampling and to perform resampling based on the resampling ratio corresponding to the minimum value; when the minimum value is greater than or equal to the characterization threshold, the decision is not to perform resampling.

As an example, for the case of a single resampling ratio, the expression for the result of resampling decision is as follows.

$$S 1 = \{ \begin{matrix}scale , {cost}_{1} \leq {cost}_{th} \\ non , Otherwise\end{matrix} \qquad ( 22 )$$

Where S1 denotes the result of the resampling decision for the representative picture, scale denotes the individual scaling ratio, non denotes not performing resampling, cost₁ denotes the cost of rate-distortion balance corresponding to the single scaling ratio, and costₜₕ denotes a cost threshold.

In this example, it may be set that scale=2.0, costₜₕ=τ·cost₀, where τ=1.05, and cost₀ is the cost of rate distortion before resampling.

For the case of at least two resampling ratios, the expression for the result of resampling decision is as follows.

$$S 1 = \{ \begin{matrix}{scale}_{n} , {min}_{n ∈ ϕ} cost ( {scale}_{n} ) \leq {cost}_{th} \\ non , Otherwise\end{matrix} \qquad ( 23 )$$

where ϕ denotes the set of scaling ratios, scaleₙ denotes the nth scaling ratio, and cost (scaleₙ) denotes the rate-distortion balance cost corresponding to the nth scaling ratio.

In this example, it may be set that ϕ={1.5, 2.0}, and costₜₕ=τ·cost₀.

At block S22: determining whether a result of the resampling decision on the representative picture is to perform resampling.

When the result is to perform resampling, S23 is executed; when the result is not to perform resampling, S24 is executed.

At block S23: performing S12-S15.

At block S24: not performing S12-S15.

With the implementation of the embodiments, a resampling decision is made based on the quality characterization value of the representative picture after resampling at the resampling ratio. The resampling technique is enabled in the codec process only when the decision result is to perform resampling. Since the decision result is to perform resampling, it means that the picture quality after resampling at the resampling ratio meets requirements and the to-be-processed video sequence is suitable for resampling at the resampling ratio. In this way, it is possible to decide whether to enable the resampling technique in the codec process based on the actual situation of the to-be-processed video sequence, and when the quality characterization value is the rate-distortion balance cost, the combination of rate and distortion for the resampling decision can effectively balance the codec performance compared with the way of using only one of rate and distortion for the resampling decision.

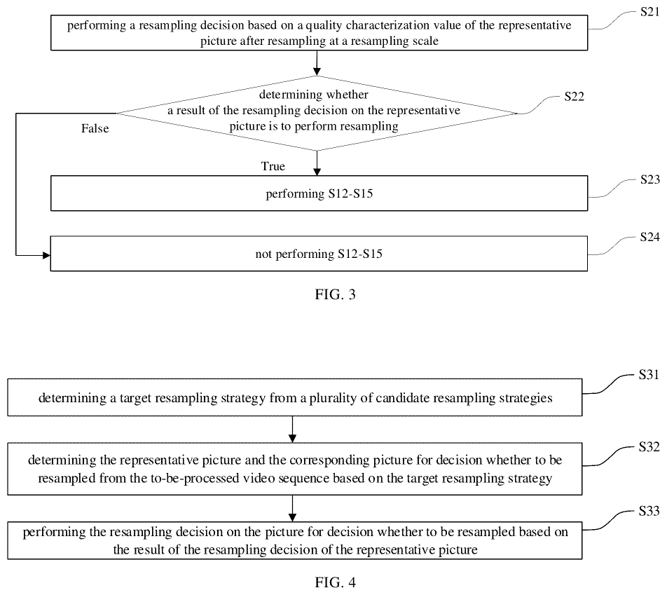

FIG. 4 is a flowchart of a video codec method according to further another embodiment of the present disclosure. It is to be noted that the present embodiment is not limited to the flow sequence shown in FIG. 4 when substantially the same results can be realized. The present embodiment is a further extension of the above embodiments. The method may include operations, prior to S14, at blocks illustrated in FIG. 4.

At block S31: determining a target resampling strategy from a plurality of candidate resampling strategies.

The correspondence between the representative picture and a picture for decision whether to be resampled in different candidate resampling strategies is different, i.e., the resampling decision methods corresponding to different candidate resampling strategies are different. The picture for decision whether to be resampled corresponding to the representative picture is a picture to be resampled or not decided based on the result of the resampling decision of the representative picture.

Different candidate resampling strategies correspond to different resampling decision methods, which can be reflected by different resampling decision complexity, different coding levels of adaptation, etc. The more the number of representative pictures, the higher the resampling decision complexity is considered, given the constant number of the pictures for decision whether to be resampled.

In some embodiments, the candidate resampling strategies may include at least two of a frame-level resampling strategy, a group-level resampling strategy, and a sequence-level resampling strategy. The frame-level resampling strategy is adapted to a frame-level coding level, the group-level resampling strategy is adapted to a picture-group coding level, and the sequence-level resampling strategy is adapted to a sequence-level coding level.

Under the frame-level resampling strategy, the representative picture and the to-be-resampled decision picture may be the same picture. That is, for each picture in the to-be-processed video sequence, the picture resampling decision is based on the picture itself.

Under the group-level resampling strategy, the representative pictures are at least some of the pictures in a GOP included in the to-be-processed video sequence, and the pictures for decision whether to be resampled are all the pictures in the GOP to which the representative pictures belong. The representative pictures in the GOP may be determined either randomly or according to a predetermined rule. For example, multiple representative pictures are randomly selected from the GOP. Another example is to select multiple pictures from the GOP in a top order as the representative pictures according to a playback order. For further another example, starting from a first picture in the GOP, one picture is selected as the representative picture for each interval of several pictures.

Under the sequence-level resampling strategy, the representative pictures are the pictures in at least some of GOPs included in the to-be-processed video sequence, and the pictures for decision whether to be resampled are all the pictures in the to-be-processed video sequence. The determination of the GOPs to which the representative pictures belong may be random or according to a predetermined rule. For example, multiple GOPs in a top order from the to-be-processed video sequence are selected as the GOPs to which the representative pictures belong according to a playback order, and the representative pictures are selected separately from the selected GOPs.

At block S32: determining the representative picture and the corresponding picture for decision whether to be resampled from the to-be-processed video sequence based on the target resampling strategy.

At block S33: performing the resampling decision on the picture for decision whether to be resampled based on the result of the resampling decision of the representative picture.

For the way to obtain the results of resampling decision of the representative picture, reference may be made to the related description of S21 above, which will not be repeated herein.

Under the group-level resampling strategy, when the representative pictures are multiple, the results of resampling decision of the pictures for decision whether to be resampled may be obtained by voting the results of resampling decision of the multiple representative pictures.

Under the sequence-level resampling strategy, when the representative picture is pictures in multiple GOPs, the result of resampling decision of the to-be-processed video sequence may be obtained by voting the results of resampling decision of multiple GOPs to which the representative pictures belong. Reference may be made to the resampling decision method under the group-level resampling strategy for the results of resampling decision of GOPs.

In S31 to S33, for example, the to-be-processed video sequence= {GOP1, GOP2, . . . , GOPk}, GOP1= {picture 1, picture 2, . . . , picture m}.

In the case where the target resampling strategy is a group-level resampling strategy, n representative pictures are selected from GOP1, and the results of resampling decision of n representative pictures are voted on to obtain the result of resampling decision of GOP1. The expression of the result of resampling decision may be as follows.

$$S 2 = \{ \begin{matrix}yes , {\sum }_{i}^{n} {s}_{i} / n \geq {s}_{th} \\ non , Otherwise\end{matrix} \qquad ( 24 )$$

Where S2 denotes the result of the resampling decision for GOP1, yes denotes that resampling is performed, non denotes no resampling is performed, sᵢ denotes the result of resampling decision of the ith representative picture in GOP1, and sₜₕ denotes a voting threshold.

In this example, it may be set that n=1, m=32, sₜₕ=0.5.

In the case where the target resampling strategy is a sequence-level resampling strategy, GOPs 1-n are selected as the GOPs to which the representative pictures belong, and the results of resampling decision of GOPs 1-n are voted on to obtain the results of resampling decision of the to-be-processed video sequence. The expression of the result of resampling decision may be as follows.

$$G = \{ \begin{matrix}yes , {\sum }_{i}^{n} {g}_{i} / n \geq {g}_{th} \\ non , Otherwise\end{matrix} \qquad ( 25 )$$

Where G denotes the result of resampling decision of the to-be-processed video sequence, gᵢ denotes the i-th GOP to which the representative pictures belong, and gₜₕ denotes a voting threshold.

In this example, it may be set that n=1, and gₜₕ=0.6.

By the implementation of the embodiments, the present disclosure selects a target resampling strategy from multiple candidate resampling strategies, and performs the resampling decision under the guidance of the target resampling strategy. Since the correspondence between the representative pictures in different candidate resampling strategies and the pictures for decision whether to be resampled differs, i.e., different candidate resampling strategies correspond to different resampling decision methods, the way of resampling decision (complexity, applicable coding level, etc.) may be controllable, thereby effectively promoting the application of resampling technology in the codec process.

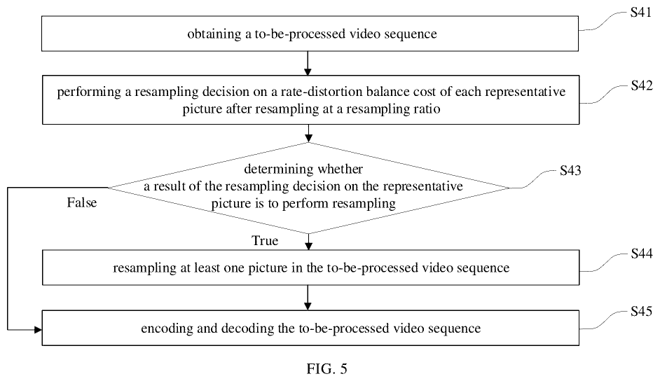

FIG. 5 is a flowchart of a video codec method according to still another embodiment of the present disclosure. It is to be noted that the present embodiment is not limited to the flow sequence shown in FIG. 5 when substantially the same results can be realized. The method may include operations at blocks illustrated in FIG. 5.

At block S41: obtaining a to-be-processed video sequence.

The to-be-processed video sequence includes at least one representative picture.

At block S42: performing a resampling decision on a rate-distortion balance cost of each representative picture after resampling at a resampling ratio.

The rate-distortion balance cost is obtained by fusing the actual rate and distortion of the representative picture after resampling at the resampling ratio. The fusion may be done by multiplication, weighting, etc. In the weighted approach, the rate-distortion balance cost is the weighted sum of the actual rate and distortion after resampling, which can be expressed as follows.

$$cost = d + μ \cdot {rate}_{1}^{′} \qquad ( 26 )$$

The number of the resampling ratio is a single or at least two. When the resampling ratio is a single value, in S42, it may be determined whether the rate-distortion balance cost corresponding to the single resampling ratio is less than a cost threshold; when the rate-distortion balance cost is less than the cost threshold, the decision is to perform resampling; when the rate-distortion balance cost is greater than or equal to the cost threshold, the decision is not to perform resampling. When the number of the resampling ratios is at least two, in S42, it may be determined whether the minimum value of the rate-distortion balance cost corresponding to at least two resampling ratios is less than the cost threshold; when the minimum value is less than the cost threshold, the decision is to perform resampling and to perform resampling based on the resampling ratio corresponding to the minimum value, when the minimum value is greater than or equal to the cost threshold, the decision is not to perform resampling.

At block S43: determining whether a result of the resampling decision on the representative picture is to perform resampling.

When the result is to perform resampling, S44-S45 are executed; when the result is not to perform resampling, S44 is not executed and S45 is directly executed.

At block S44: resampling at least one picture in the to-be-processed video sequence.

The at least one picture is each a picture that is resampled based on the representative picture for decision making.

At block S45: encoding and decoding the to-be-processed video sequence.

For pictures that have been resampled, coding and decoding are performed on the basis of the resampling results; for pictures that have not been resampled, coding and decoding are performed on the basis of the original picture.

For other detailed descriptions of the embodiments, reference may be made to the previous embodiments, which will not be repeated herein.

By the implementation of the embodiments, the present disclosure does not directly enable the resampling technique in the codec process of the to-be-processed video sequence, but makes a resampling decision based on the rate-distortion balance cost of the representative picture after resampling at the resampling ratio, and only enables the resampling technique in the codec process when the decision result is to perform resampling. The decision result being to perform resampling means that the picture quality after resampling at the resampling ratio meets requirements and the to-be-processed video sequence is suitable for resampling at the resampling ratio. Therefore, it is possible to decide whether to enable the resampling technique in the codec process according to the actual situation of the to-be-processed video sequence. Moreover, the resampling decision made based on the rate-distortion balance cost (combining rate and distortion) can effectively balance the codec performance compared with the resampling decision using only one of the rate and distortion.

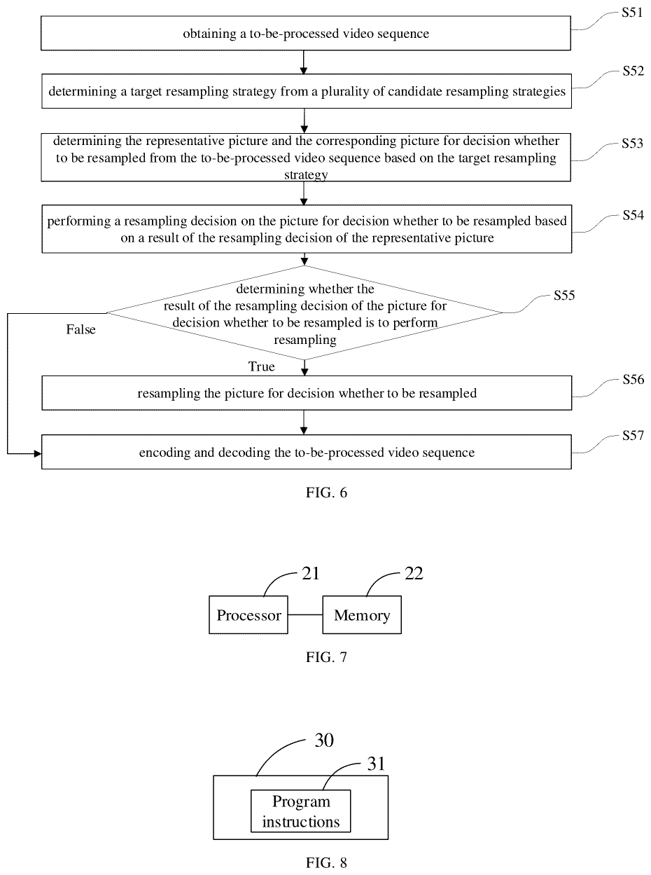

FIG. 6 is a flowchart of a video codec method according to still another embodiment of the present disclosure. It is to be noted that the present embodiment is not limited to the flow sequence shown in FIG. 6 when substantially the same results can be realized. The method may include operations at blocks illustrated in FIG. 6.

At block S51: obtaining a to-be-processed video sequence.

At block S52: determining a target resampling strategy from a plurality of candidate resampling strategies.

The correspondence between the representative picture and a picture for decision whether to be resampled in different candidate resampling strategies is different, i.e., the resampling decision methods corresponding to different candidate resampling strategies are different.

The candidate resampling strategies may include at least two of a frame-level resampling strategy, a group-level resampling strategy, and a sequence-level resampling strategy. The frame-level resampling strategy is adapted to a frame-level coding level, the group-level resampling strategy is adapted to a picture-group coding level, and the sequence-level resampling strategy is adapted to a sequence-level coding level.

Under the frame-level resampling strategy, the representative picture and the to-be-resampled decision picture may be the same picture.

Under the group-level resampling strategy, the representative pictures are at least some of the pictures in a GOP included in the to-be-processed video sequence, and the pictures for decision whether to be resampled are all the pictures in the GOP to which the representative pictures belong. The representative pictures in the GOP may be determined either randomly or according to a predetermined rule. For example, multiple representative pictures are randomly selected from the GOP. Another example is to select multiple pictures from the GOP in a top order as the representative pictures according to a playback order. For further another example, starting from a first picture in the GOP, one picture is selected as the representative picture for each interval of several pictures.

Under the sequence-level resampling strategy, the representative pictures are the pictures in at least some of GOPs included in the to-be-processed video sequence, and the pictures for decision whether to be resampled are all the pictures in the to-be-processed video sequence. The determination of the GOPs to which the representative pictures belong may be random or according to a predetermined rule. For example, multiple GOPs in a top order from the to-be-processed video sequence are selected as the GOPs to which the representative pictures belong according to a playback order, and the representative pictures are selected separately from the selected GOPs.

At block S53: determining the representative picture and the corresponding picture for decision whether to be resampled from the to-be-processed video sequence based on the target resampling strategy.

At block S54: performing a resampling decision on the picture for decision whether to be resampled based on a result of the resampling decision of the representative picture.

Under the group-level resampling strategy, when the representative pictures are multiple, the results of resampling decision of the pictures for decision whether to be resampled may be obtained by voting the results of resampling decision of the multiple representative pictures.

Under the sequence-level resampling strategy, when the representative picture is pictures in multiple GOPs, the result of resampling decision of the to-be-processed video sequence may be obtained by voting the results of resampling decision of multiple GOPs to which the representative pictures belong.

At block S55: determining whether the result of the resampling decision of the picture for decision whether to be resampled is to perform resampling.

When the result is to perform resampling, S56-S57 are executed; when the result is not to perform resampling, S56 is not executed and S57 is directly executed.

At block S56: resampling the picture for decision whether to be resampled.

At block S57: encoding and decoding the to-be-processed video sequence.

For pictures that have been resampled, coding and decoding are performed on the basis of the resampling results; for pictures that have not been resampled, coding and decoding are performed on the basis of the original picture.

By the implementation of the embodiments, the present disclosure proposes multiple candidate resampling strategies, each candidate resampling strategy applies different resampling decision methods, which can effectively promote the application of resampling technology in the codec process.

It should be noted that any embodiments of the present disclosure may be combined with each other. The embodiments related to the determination method of the resampling strategy, the resampling decision method, and the acquisition method of the offset value of quantization parameters in the video codec process may be implemented individually or in combination. For combined implementation, in the case of combined implementation of the determination method of resampling strategy and the resampling decision method, the resampling strategy shall be determined based on the determination method of the resampling strategy first, and then the resampling decision shall be made based on the resampling decision method under the determined resampling strategy; in the case of combined implementation of the resampling decision method and the acquisition method of offset value of quantization parameters, the resampling decision shall be made based on the resampling decision method first, and then the offset value of quantization parameters shall be obtained based on the acquisition method of the offset value of quantization parameters. in the case of combined implementation of the determination method of resampling strategy, the resampling decision method, and the acquisition method of the offset value of quantization parameters, the resampling strategy shall be determined based on the determination method of the resampling strategy first, then the resampling decision shall be made based on the resampling decision method under the determined resampling strategy, and finally the offset value of quantization parameters shall be obtained based on the acquisition method of the offset value of quantization parameters.

FIG. 7 is a structural schematic view of an electronic device according to an embodiment of the present disclosure. As shown in FIG. 7, the electronic device includes a processor 21 and a memory 22 coupled to the processor 21.

The memory 22 stores program instructions for implementing the method of any of the above embodiments; and the processor 21 is configured to execute the program instructions stored in the memory 22 to implement the steps of the above methods. The processor 21 may also be referred to as a central processing unit (CPU). The processor 21 may be an integrated circuit chip with signal processing capability. The processor 21 may be a general-purpose processor, a digital signal processor (DSP), an application specific integrated circuit (ASIC), a field programmable gate array (FPGA), or other programmable logic device, a discrete gate or transistor logic device, or a discrete hardware component. The general-purpose processor may be a microprocessor or the processor may be any conventional processor, etc.

FIG. 8 is a structural schematic view of a computer-readable storage medium according to an embodiment of the present disclosure. As shown in FIG. 8, the computer-readable storage medium 30 stores program instructions 31 which, when executed, implement the method provided by the above embodiments of the present disclosure. In particular, the program instructions 31 may be stored in the computer-readable storage medium 30 as a program file in the form of a software product to cause a computer device (which may be a personal computer, a server, or a network device, etc.) or processor to perform all or some of the steps of the method of each embodiment of the present disclosure. The computer-readable storage medium 30 includes: USB flash drive, mobile hard disk, read-only memory (ROM), random access memory (RAM,), disk or CD-ROM, and other various media that can store program code, or a computer, server, cell phone, tablet and other terminal devices.

### Implementation II

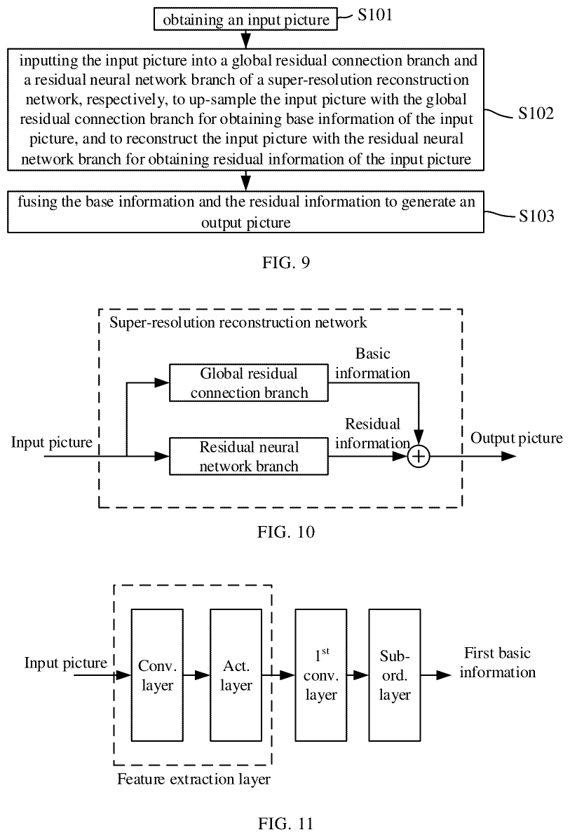

Referring to FIGS. 9 and 10, FIG. 9 is a flowchart of a picture reconstruction method according to an embodiment of the present disclosure, and FIG. 10 is a structural schematic view of a super-resolution reconstruction network according to an embodiment of the present disclosure. It should be noted that the picture reconstruction method described in the embodiments is not limited to the following steps.

At block S101: obtaining an input picture.

In the embodiments, the input picture is obtained, and the input picture is a picture to be reconstructed at super resolution. The input picture may be a reconstructed picture processed with reconstructed pixels, or, the input picture may be a reconstructed picture as well as a picture formed using edge information. The edge information may include one or more of prediction information, quantization parameter information, division information, etc., without limitation herein. Taking quantization parameter information as an example, a picture may be constructed with the quantization parameter information, and a pixel value of each pixel point in the picture is a quantization parameter.

In the process of encoding the picture, the reconstructed picture is an encoded reconstructed picture; in the process of decoding the picture, the reconstructed picture is a decoded reconstructed picture.

At block S102: inputting the input picture into a global residual connection branch and a residual neural network branch of a super-resolution reconstruction network, respectively, to up-sample the input picture with the global residual connection branch for obtaining basic information of the input picture, and to reconstruct the input picture with the residual neural network branch for obtaining residual information of the input picture.

In the embodiments, the input picture is input into a super-resolution reconstruction network, and the super-resolution reconstruction network includes a global residual connection branch and a residual neural network branch. The input picture is input into the global residual connection branch and the residual neural network branch respectively, and the global residual connection branch is configured to up-sample the input picture in advance to obtain the basic information of the input picture, thereby providing a base value for the input picture; and the residual neural network branch is configured to reconstruct the input picture to obtain the residual information of the input picture, thereby obtaining more information of the input picture. It is easy to understand that the residual information is more complex compared to the information contained in the basic information, i.e., the residual information has more high frequency information.

The base and/or residual information may be represented by means of feature maps or other data information, without limitation herein.

At block S103: fusing the basic information and the residual information to generate an output picture.

In the embodiments, after obtaining the basic information and the residual information, the output picture is generated by fusing the basic information and the residual information, and the output picture may contain information contained in both the basic information and the residual information. In other words, the output picture contains both the basic information of the input picture and the high-frequency information processed by the residual neural network branch, thereby facilitating the realization of a good super-resolution reconstruction effect.

It can be seen that in the embodiments, the super-resolution reconstruction network includes the global residual connection branch and the residual neural network branch, thus the super-resolution reconstruction network has a reasonable network structure, thereby improving the performance of the super-resolution reconstruction network; the basic information obtained with the global residual connection branch may contain the basic information of the input picture, and the residual information obtained with the residual neural network branch may contain more high-frequency information. The output picture generated by fusing the two contains both the basic information of the input picture and the high-frequency information processed by the residual neural network branch, which is conducive to achieving a good super-resolution reconstruction effect.

The following is an example of the global residual connected branch of the present disclosure. Referring to FIGS. 10 and 11 in conjunction, FIG. 11 is a structural schematic view of a convolutional neural network according to an embodiment of the present disclosure.

In some embodiments, the global residual connection branch may include at least one up-sampling processing module, and the input picture is up-sampled with the at least one up-sampling processing module, respectively, to obtain sub-basic information corresponding to each up-sampling processing module; each at least one up-sampling processing module includes at least one type of a convolutional neural network and an a priori filter.

Based on the sub-basic information corresponding to each up-sampling processing module, the basic information for fusion with the residual information is obtained. The sub-basic information corresponding to each up-sampling processing module includes first sub-basic information obtained with the convolutional neural network, and second sub-basic information obtained with the a priori filter.

In other words, based on the sub-basic information corresponding to each up-sampling processing module, the basic information may be obtained as follows: when the first sub-basic information is obtained with the convolutional neural network, the first sub-basic information is taken as the basic information for fusion with the residual information; when the second sub-basic information is obtained with the a priori filter, the second sub-basic information is taken as the basic information for fusion with the residual information; when the first sub-basic information is obtained with the convolutional neural network and the second sub-basic information is obtained with the a priori filter, the first sub-basic information may be fused with the second sub-basic information to generate the basic information for fusion with the residual information. The technical solution for fusing the first sub-basic information with the second sub-basic information to obtain the basic information will be described in detail later, and the implementation of obtaining the first sub-basic information with the convolutional neural network and obtaining the second sub-basic information with the a priori filter is described in detail below.

The input picture is up-sampled with the convolutional neural network to obtain the first sub-basic information. Specifically, the convolutional neural network includes a feature extraction layer, a first convolutional layer, and a subordination layer that are sequentially cascaded. The convolutional neural network may include several sequentially connected feature extraction layers, and an example of an implementation of the convolutional neural network including a single feature extraction layer is shown in FIG. 11. The feature extraction layer is configured to extract features of the input picture, and an output of the feature extraction layer is configured as an input of the first convolutional layer to obtain feature maps of multiple channels, which are configured to represent the input picture after convolution; the subordination layer is configured to fuse the feature maps of multiple channels to obtain the first sub-basic information.

For example, the number of the input channel of the convolutional neural network is one to allow the input picture to be input into the feature extraction layer, and the feature extraction layer includes a convolutional layer and an activation layer which are connected sequentially. The convolutional layer of the feature extraction layer has a 3*3 convolutional kernel, and the extracted feature number is 64, in order to mitigate the large amount of data to be processed by the super-resolution reconstruction network due to a large extracted feature number, and also to mitigate the poor reconstruction effect of the super-resolution reconstruction network due to a large extracted feature number. In other words, the set extracted feature number may reduce the operational cost of the super-resolution reconstruction network while ensuring the reconstruction effect; the activation layer may apply a ReLU function to activate the feature maps, the first convolutional layer is used to convolve again for feature extraction to obtain feature maps of four channels, and the subordination layer is used to fuse the feature maps of four channels to obtain the first sub-basic information. The subordination layer may process the feature maps of the four channels using a Shuffle function, etc.

It should be noted that for the sake of understanding, the following example is illustrated with the extracted feature number of the feature extraction layer as 64, and when the extracted feature number of the feature extraction layer is changed, the value of the following example shall be changed accordingly.

And/or, the input picture is up-sampled with the a priori filter, and the a priori filter performs up-sampling by means of an up-sampling interpolation filtering to obtain the second sub-basic information. In some embodiments, the a priori filter may be a reference picture resampling filter, a bilinear cubic interpolation filter, a bilinear interpolation filter, a nearest neighbor interpolation filter, etc.

For example, when the a priori filter is a resampling filter, the input picture includes a luminance component as well as a chrominance component. For example, when the input picture is in YUV format, the luminance component is Y and the chrominance components are U and V.

The input picture is subjected to up-sampling interpolation filtering with the resampling filter in which a tap coefficient corresponding to the luminance component is greater than a tap coefficient corresponding to the chrominance component.

For example, the resampling filter includes 16 arrays of 8-tap filter coefficients and 32 arrays of 4-tap filter coefficients. The 16 arrays of 8-tap filter coefficients are for up-sampling interpolation filtering of the luminance component, and the 32 arrays of 4-tap filter coefficients are for up-sampling interpolation filtering of the chrominance component.

The arrays of filter coefficients corresponding to the luminance component are as follows.
{0, 0, 0, 64, 0, 0, 0, 0, 0}
{0, 1, −3, 63, 4, −2, 1, 0}
{−1, 2, −5, 62, 8, −3, 1, 0}
{−1, 3, −8, 60, 13, −4, 1, 0}
{−1, 4, −10, 58, 17, −5, 1, 0}
{−1, 4, −11, 52, 26, −8, 3, −1}
{−1, 3, −9, 47, 31, −10, 4, −1}
{−1, 4, −11, 45, 34, −10, 4, −1}
{−1, 4, −11, 40, 40, −11, 4, −1}
{−1, 4, −10, 34, 45, −11, 4, −1}
{−1, 4, −10, 31, 47, −9, 3, −1}
{−1, 3, −8, 26, 52, −11, 4, −1}
{0, 1, −5, 17, 58, −10, 4, −1}
{0, 1, −4, 13, 60, −8, 3, −1}
{0, 1, −3, 8, 62, −5, 2, −1}
{0, 1, −2, 4, 63, −3, 1, 0}

The arrays of filter coefficients corresponding to the chromaticity component are as follows.
{0, 64, 0, 0}
{−1, 63, 2, 0}
{−2, 62, 4, 0}
{−2, 60, 7, −1}
{−2, 58, 10, −2}
{−3, 57, 12, −2}
{−4, 56, 14, −2}
{−4, 55, 15, −2}
{−4, 54, 16, −2}
{−5, 53, 18, −2}
{−6, 52, 20, −2}
{−6, 49, 24, −3}
{−6, 46, 28, −4}
{−5, 44, 29, −4}
{−4, 42, 30, −4}
{−4, 39, 33, −4}
{−4, 36, 36, −4}
{−4, 33, 39, −4}
{−4, 30, 42, −4}
{−4, 29, 44, −5}
{−4, 28, 46, −6}
{−3, 24, 49, −6}
{−2, 20, 52, −6}
{−2, 18, 53, −5}
{−2, 16, 54, −4}
{−2, 15, 55, −4}
{−2, 14, 56, −4}
{−2, 12, 57, −3}
{−2, 10, 58, −2}
{−1, 7, 60, −2}
{0, 4, 62, −2}
{0, 2, 63, −1}

For the selection of the filter coefficients, the values may be assigned by combining the coordinate value of the current pixel in the output picture, the size of the input picture, and the size of the output picture.

Specifically, the filter coefficients in the row direction of the resampling filter may be assigned in combination with the coordinate value of the current pixel in the output picture, the width of the input picture, and the width of the output picture; and the filter coefficients in the column direction of the resampling filter may be assigned in combination with the coordinate value of the current pixel in the output picture, the height of the input picture, and the height of the output picture.

As an example, it may be set that the coordinates of the current pixel in the output picture are (x, y), and the filter coefficients in the row direction of the frac-th row are defined as follows.

$$frac = ( ( x * orgWidth << 4 ) / scaledWidth ) \& numFracPositions \qquad ( 1 - 1 )$$

The filter coefficients in the column direction of the frac-th row are defined as follows.

$$frac = ( ( y * orgHeight << 4 ) / scaledHeight ) \& numFracPositions \qquad ( 1 - 2 )$$

Where the value of frac is [0,15]; orgWidth indicates the width of the input picture, scaledWidth indicates the width of the output picture, orgHeight indicates the height of the input picture, and scaledHeight indicates the height of the output picture; numFracPositions indicates a filter coefficient calculation parameter, and the value of numFracPositions is a first preset value when calculating the filter coefficients of the luminance component, and the value of numFracPositions is a second preset value when calculating the filter coefficients of the chrominance component.

The first preset value may be 15 and the second preset value may be 31, as exemplified in this example “The 16 arrays of 8-tap filter coefficients are for up-sampling interpolation filtering of the luminance component, and the 32 arrays of 4-tap filter coefficients are for up-sampling interpolation filtering of the chrominance component”. Of course, when using other resampling filters for up-sampling interpolation filtering, the first preset value and the second preset value may change accordingly, without limitation herein.

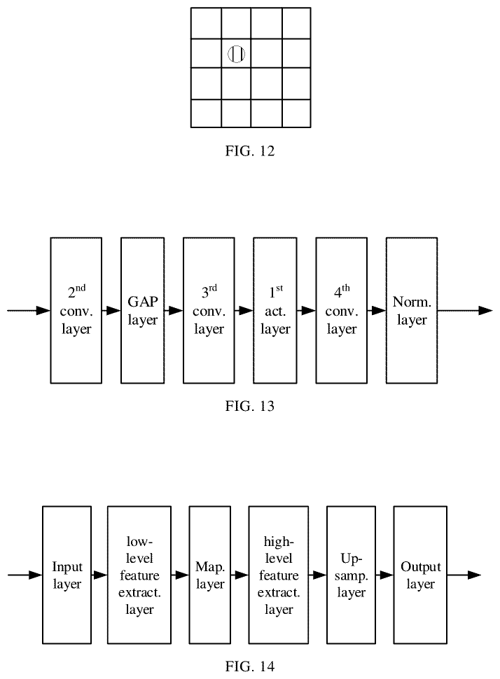

Referring to FIG. 12, FIG. 12 is a structural schematic view of a 4*4 neighborhood of a to-be-interpolated pixel point according to an embodiment of the present disclosure.

As an example, the a priori filter is a bilinear cubic interpolation filter, which may be used to up-sample the input picture for interpolation filtering.

4*4 neighborhood points within a preset range of the to-be-interpolated pixel point are obtained to obtain the pixel value of the to-be-interpolated pixel point using the coordinate values of the neighborhood points. The preset range may be a range including the to-be-interpolated pixel point, such as the 4*4 neighborhood points in the preset range shown in FIG. 12, with the shaded circle for representing the to-be-interpolated pixel point.

Let the coordinates of the to-be-interpolated pixel point be (x, y), and the pixel value of the to-be-interpolated pixel point is defined as follows.

$$f ( x , y ) = {\sum }_{i = 0}^{3} {\sum }_{j = 0}^{3} f ( {x}_{i} , {y}_{j} ) \cdot W ( x - {x}_{i} ) \cdot W ( y - {y}_{j} ) \qquad ( 1 - 3 )$$

Where f(x, y) denotes the pixel value of the to-be-interpolated pixel point; (xᵢ, yᵢ) denotes the coordinates of the neighboring point, where i=0, 1, 2, 3 and j=0, 1, 2, 3; f(xᵢ, yᵢ) denotes the pixel value of the to-be-interpolated pixel point, and W denotes the bilinear interpolation function.

The pixel value of the to-be-interpolated pixel point and the bilinear cubic interpolation function are combined to up-sample the input picture for interpolation filtering, thereby obtaining the second sub-basic information.

As an example, the bilinear cubic interpolation function is defined as follows.

$$W ( x ) = \{ \begin{matrix}( a + 2 ) \cdot {\vert x \vert}^{3} - ( a + 3 ) \cdot {\vert x \vert}^{2} + 1 , \vert x \vert \leq 1 \\ ( a ) \cdot {\vert x \vert}^{3} - 5 a \cdot {\vert x \vert}^{2} + 8 a \vert x \vert - 4 a , 1 < \vert x \vert < 2 \\ 0 , \vert x \vert \geq 2\end{matrix} \} \qquad ( 1 - 4 )$$

where a is a third preset value. For example, the value of a in the embodiments may be −0.5.

The following specifies the specific implementation of the weighted fusion of the first sub-basic information and the second sub-basic information after obtaining the first sub-basic information and the second sub-basic information.

Specifically, weights may be assigned to the first sub-basic information and the second sub-basic information in advance, or weights may be assigned to the first sub-basic information and the second sub-basic information through a first attention layer.

When assigning weights to the first sub-basic information and the second sub-basic information in advance, the expressions of the basic information are as follows.

$$0 = {\sum }_{j = 1}^{N} {w}_{j} \cdot {I}_{j} \qquad ( 1 - 5 )$$

Where N is the total number of up-sampling methods, and the number of the up-sampling methods may be one or more, including but not limited to the use of the a priori filter and convolutional neural network as described in the above embodiments; wⱼ is the weight assigned to the different up-sampling methods, wⱼ may be set artificially or learned by the network, and Σⱼ₌₁^{N}wⱼ=1; Iⱼ is the output picture of the different up-sampling methods; and 0 is the basic information.

It is noted that when generating the first sub-basic information separately using several convolutional neural networks, and when generating the second sub-basic information separately using several a priori filters, weights are assigned to each first sub-basic information and each second sub-basic information, and the sum of the weight of each first sub-basic information and the weight of each second sub-basic information is 1.

Taking N=2 as an example, I₁ is the first sub-basic information obtained using the convolutional neural network and I₂ is the second sub-basic information obtained using the resampling filter, and the same weight may be assigned to both, i.e., w₁=w₂=0.5, O=0.5I₁+0.5I₂.

When assigning weights to the first sub-basic information and the second sub-basic information through the first attention layer, it means that the global residual connection branch includes the first attention layer. The first attention layer may be an attention module, etc., capable of adaptive weight assignment, which can effectively improve the performance of the global residual connection branch and thus improve the performance of the super-resolution reconstruction network. Referring to FIG. 13, FIG. 13 is a structural schematic view of a first attention layer according to an embodiment of the present disclosure.

The first attention layer includes a second convolutional layer, a global average pooling (GAP) layer, a third convolutional layer, a first activation layer, a fourth convolutional layer, and a normalization layer that are sequentially cascaded.

Fusing the first sub-basic information with the second sub-basic information may be done by fusing the first sub-basic information with the second sub-basic information in an input channel of the first attention layer, and inputting the fused information into the second convolutional layer for feature extraction, where the convolutional kernel of the second convolutional layer may be 1*1, and the extracted feature number may be 64; performing global average pooling on the feature map output from the second convolutional layer with the GAP layer; performing feature extraction on the output of the GAP layer with the third convolutional layer, where the convolutional kernel of the third convolutional layer may be 1*1, and the extracted feature number may be 64; taking the output of the third convolutional layer as the input of the first activation layer, performing activation processing with the first activation layer, and inputting the activated feature map to the fourth convolutional layer for feature extraction, where the convolutional kernel of the fourth convolutional layer may be 1*1, and the extracted feature number may be 64; performing normalization activation on the output of the fourth convolutional layer with the normalization layer, where the normalization layer may adopt a softmax (normalized activation) function to obtain the weights corresponding to the first sub-basic information and the second sub-basic information, assign weights to the first sub-basic information and the second sub-basic information, and perform weighted fusion on the first sub-basic information and the second sub-basic information with the obtained weights, thereby obtaining the basic information.

Similarly, when generating the first sub-basic information using several convolutional neural networks, and when generating the second sub-basic information using several a priori filters, weights are assigned to each first sub-basic information and each second sub-basic information, and the sum of the weight of each first sub-basic information and the weight of each second sub-basic information is 1.

The above is an example elaboration of the global residual connection branch of the super-resolution reconstruction network, and the following is an example elaboration of the residual neural network branch of the super-resolution reconstruction network.

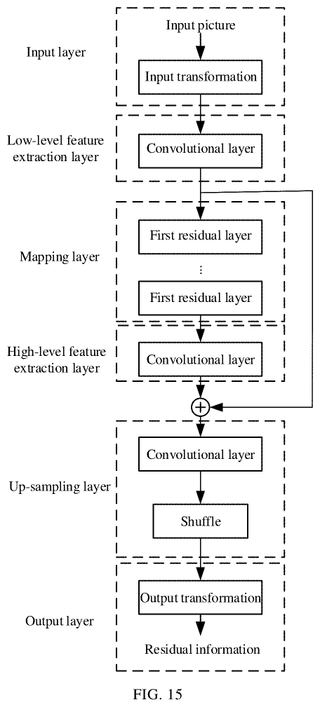

Referring to FIGS. 14 and 15, FIG. 14 is a structural schematic view of a residual neural network according to an embodiment of the present disclosure and FIG. 15 is a structural schematic view of a residual neural network according to another embodiment of the present disclosure.

In some embodiments, the residual neural network includes a low-level feature extraction layer, a mapping layer, a high-level feature extraction layer, and an up-sampling layer that are sequentially cascaded, and an output of the low-level feature extraction layer is connected to the up-sampling input to form a local residual connection branch. Further, the residual neural network further includes an input layer and an output layer, where the input layer is connected to the low-level feature extraction layer and the output layer is connected to the up-sampling layer.

The input picture is input to the input layer of the residual neural network, and an input transformation process is performed on the input picture so that the form of the transformed input picture matches the form of the allowed input of the low-level feature extraction layer, and the transformed input picture is taken as the input of the low-level feature extraction layer; and/or, residual information is input to the output layer, and an output transformation process is performed on the residual information so that the result of up-sampling by the residual neural network is converted into the desired output form, and the transformed residual information is taken as the output of the residual neural network branch.

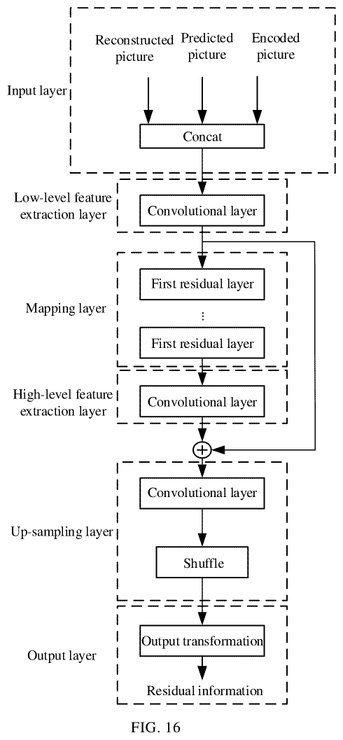

As shown in FIG. 16, FIG. 16 is a structural schematic view of a residual neural network according to further another embodiment of the present disclosure. Taking the input layer for input transform processing of the input picture as an example, the input picture includes a low-resolution encoded picture, a low-resolution predicted picture, and a quantization parameter (QP) picture, where the QP picture is a picture formed by filling the QP. A concat function is used to fuse the low-resolution coded picture, the low-resolution predicted picture, and the QP (quantization parameter) picture.

Referring further to FIGS. 14 and 15, the low-level feature extraction layer may include a convolutional layer with a convolutional kernel of 3*3 and an extracted feature number of 64. With the low-level feature extraction layer, the input picture can be mapped to the feature domain to extract the low-level feature picture of the input picture; wherein the low-level feature picture is nonlinear.

The mapping layer may include multiple residual layers, and the residual layers may be a first residual layer, a second residual layer, a third residual layer, and a fourth residual layer. With the mapping layer, the nonlinear low-level feature picture is mapped into a first high-level feature picture. For example, the mapping layer includes multiple sequentially connected first residual layers, such as including 16 residual layers to adequately map the low-level feature picture to the first high-level feature picture of higher complexity. The structure of the mapping layer will be specified later.

The high-level feature extraction layer may include a convolutional layer with a convolutional kernel of 3*3 and an extracted feature number of 64. The high-level feature extraction layer is configured to perform feature extraction on the first high-level feature picture and obtain a second high-level feature picture. The local residual connection branch is configured to fuse the low-level feature picture and the second high-level feature picture to obtain a fused feature picture. That is, the local residual connection branch is connected from the output of the low-level feature extraction layer to the output of the high-level feature extraction layer. It is noted that, among the low-level feature picture, the first high-level feature picture, and the second high-level feature picture, the high-level and low-level are corresponding concepts to describe the complexity of the feature pictures, and in general, the complexity of the high-level feature picture is higher than the complexity of the low-level feature picture. For example, the second high-level feature picture is obtained by mapping the low-level feature picture, and the second high-level feature picture contains more complex information than the low-level feature picture, i.e., the second high-level feature picture has more high-frequency information.

The up-sampling layer may include a convolutional layer and a Shuffle function, and the residual information is obtained by expanding the dimension of the fused feature picture as well as up-sampling by the up-sampling layer. For example, the convolution kernel of 3*3 may be used to convolve the fused feature picture to perform dimension expansion and up-sampling to generate a 256-channel feature map, and the Shuffle function may be used to process the dimension-expanded fused feature picture to form feature maps of 64 channels to match the number of input channels of the output layer, so that the fused feature map is transformed into a form allowed to be input to the output layer. The output layer is used to transform and fuse the 64-channel feature map into one channel as the output of the residual neural network, i.e., as the residual information used for fusion with the base picture.

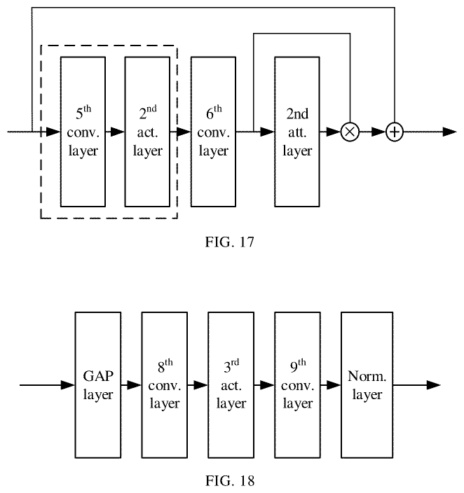

The following is an example of the mapping layer of the present disclosure. Referring to FIG. 17 and FIG. 18, FIG. 17 is a structural schematic view of a first residual layer according to an embodiment of the present disclosure, and FIG. 18 is a structural schematic view of a second attention layer according to an embodiment of the present disclosure.

In some embodiments, the first residual layer includes a fifth convolutional layer, a second activation layer, a sixth convolutional layer, and a second attention layer. Specifically, the low-level feature picture/the feature map output from preceding residual layer is input to the fifth convolutional layer, and the low-level feature picture/the feature map output from preceding residual layer is feature extracted with the fifth convolutional layer, where the convolution kernel of the fifth convolutional layer is 3*3, and the extracted feature number is 64; the output of the fifth convolutional layer is activated with the second activation layer (e.g., ReLU function, etc.); and the output of the second activation layer is feature extracted with the sixth convolutional layer, where the sixth convolutional layer has a convolutional kernel of 3*3 and the extracted feature number is 64, to obtain multiple mapped feature pictures corresponding to multiple channels; multiple mapped feature pictures are input to the second attention layer, and weights assigned to each mapped feature picture are obtained with the second attention layer; the mapped feature pictures are weighted and fused, and the weighted fused picture is fused with the current input of the first residual layer (the low-level feature picture/the feature map output from preceding residual layer). The second attention layer may be an attention module, etc., capable of adaptive weight assignment, which can effectively improve the performance of the residual neural network branches and thus the performance of the super-resolution reconstruction network.

The fifth convolutional layer and the second activation layer shown in FIG. 17 may serve as a feature extraction layer, and the first residual layer may include one or more feature extraction layers without limitation herein, and an implementation in which the first residual layer includes a single feature extraction layer is shown by way of example in FIG. 17.

Further, the second attention layer includes a global average pooling layer, an eighth convolutional layer, a third activation layer, a ninth convolutional layer, and a normalization layer that are sequentially cascaded. The global average pooling layer performs global average pooling on the mapped feature picture; the eighth convolutional layer is configured to extract features from the feature map after the global average pooling process, where the convolutional kernel of the eighth convolutional layer is 1*1, and the extracted feature number is 64; the third activation layer (e.g., ReLU function, etc.) activates the feature map output from the eighth convolutional layer, and inputs the activated feature map into the ninth convolutional layer for feature extraction, where the ninth convolutional layer has a convolutional kernel of 1*1 and an extracted feature number of 64; the normalization layer (e.g., softmax function, etc.) is configured to perform normalized activation processing on the output of the ninth convolutional layer, so that after the low-level feature map is mapped to more complex features, weights are assigned to each component of the input picture to achieve automatic weighting, thereby improving the performance of the super-resolution reconstruction network. For example, weighted fusion is performed for the coded picture, the predicted picture, and the QP picture of the input residual neural network branch shown in FIG. 16.

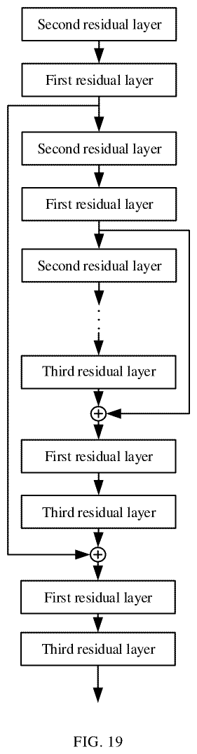

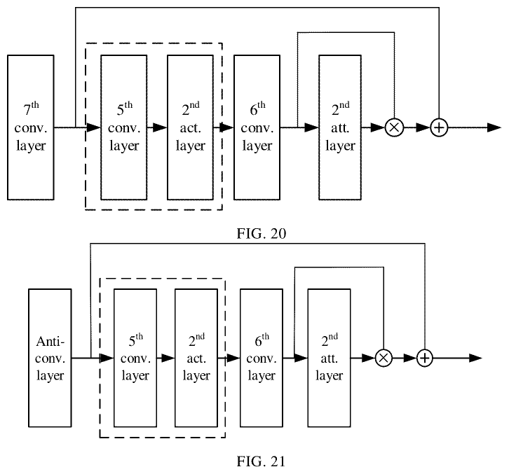

Referring to FIG. 17, FIG. 19, FIG. 20, and FIG. 21 in combination, FIG. 19 is a structural schematic view of a mapping layer according to an embodiment of the present disclosure, FIG. 20 is a structural schematic view of a second residual layer according to an embodiment of the present disclosure, and FIG. 21 is a structural schematic view of a third residual layer according to an embodiment of the present disclosure.

In some embodiments, the mapping layer further includes multiple second residual layers and multiple third residual layers, and the first residual layers, the second residual layers, and the third residual layers are connected. The second residual layer is configured to up-sample the feature map, the third residual layer is configured to down-sample the feature map, and the first residual layer, the second residual layer, and the third residual layer are connected to fuse more information of the input picture by applying feature scale transformation to the feature map, thereby facilitating the improvement of super-resolution reconstruction.

Specifically, the second residual layer includes a seventh convolutional layer spanning greater than one and a first residual layer, and the seventh convolutional layer is connected to the first residual layer to down-sample the feature map input to the second residual layer. That is, the second residual layer includes a sequentially connected seventh convolutional layer, a fifth convolutional layer, a second activation layer, a sixth convolutional layer, and a second attention layer. The output of the sixth convolutional layer is weighted and fused with the weights assigned by the second attention layer, and the feature map output from the seventh convolutional layer is fused with the weighted fused features through the local residual connection to enrich the information contained within the feature map. The second attention layer may be shown in FIG. 18, and the specific way of assigning weights will not be described herein.

The third residual layer includes an anti-convolutional layer spanning more than one and a first residual layer, and the anti-convolutional layer is connected to the first residual layer to up-sample the feature map input to the third residual layer. That is, the third residual layer includes a sequentially connected anti-convolutional layer, a fifth convolutional layer, a second activation layer, a sixth convolutional layer, and a second attention layer. The output of the sixth convolutional layer is weighted and fused with the weights assigned by the second attention layer, and the feature map output from the anti-convolutional layer is fused with the weighted fused features through the local residual connection to enrich the information contained within the feature map. The second attention layer may be shown in FIG. 18, and the specific way of assigning weights will not be described herein.

The fifth convolutional layer and the second activation layer shown in FIG. 20 and FIG. 21 may serve as a feature extraction layer, and the first residual layer may include one or more feature extraction layers without limitation herein, and the implementations in which the first residual layer includes a single feature extraction layer are shown by way of example in FIG. 20 and FIG. 21, respectively.

The first residual layers, with output feature maps being size-matched, are connected to fuse the matching feature maps. For example, the span of the seventh convolutional layer may be 2, and accordingly, the span of the anti-convolutional layer is 2. The structure of the mapping layer may be as shown in FIG. 19, where it is easily understood that the size of the feature map output by the first residual layer on the left matches the size of the feature map output by the first residual layer on the right, and thus the outputs of the two first residual layers are connected through the local residual connection branch to fuse the feature maps output by the two first residual layers. It should be noted that when the span of the seventh convolutional layer is different from the span of the anti-convolutional layer, the mapping layers should be connected differently and the output feature maps with matched size should be fused.

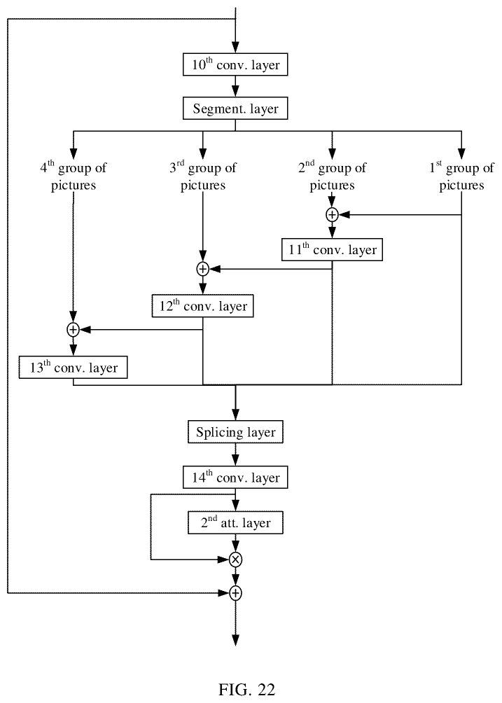

Referring to FIG. 22, FIG. 22 is a structural schematic view of a fourth residual layer according to an embodiment of the present disclosure.

The mapping layer may further include multiple fourth residual layers that are sequentially cascaded, capable of performing feature extraction on the feature maps output from the low-level feature picture/residual layer and divide the extracted feature maps to obtain multiple groups of pictures; performing multiple fusions on the multiple groups of pictures to obtain multiple fused groups of pictures, performing feature extraction on the multiple fused groups of pictures to obtain multiple fused feature maps; performing weighted fusion on the multiple fused feature maps, and fusing the weighted fused feature maps with the low-level feature pictures.

Specifically, as illustrated in FIG. 22, the fourth residual layer includes a tenth convolutional layer, a segmentation layer, an eleventh convolutional layer, a twelfth convolutional layer, a thirteenth convolutional layer, a splicing layer, a fourteenth convolutional layer, and a second attention layer.

The low-level feature picture/feature maps output from the preceding residual layer are input to the tenth convolutional layer for feature extraction, and the convolution kernel of the tenth convolutional layer is 1*1, and the extracted feature number is 64. The feature maps output from the tenth convolutional layer are divided into four groups with the segmentation layer, which are a first group of pictures, a second group of pictures, a third group of pictures, and a fourth group of pictures; for example, the feature maps may be grouped using a Split function, either by dividing the feature maps equally to form groups containing an equal number of feature maps, or by varying the number of feature maps contained in each group of pictures. The following is an example of the equal number of feature maps contained in each group of pictures, i.e., each group of pictures includes 16 feature maps.

The first group of pictures is fused with the second group of pictures to obtain a first fused group of pictures, and the first fused group of pictures is input to the eleventh convolutional layer for feature extraction to obtain a first fused feature map, where the convolutional kernel of the eleventh convolutional layer is 3*3, and the extracted feature number is 16; the first fused feature map is fused with the third group of pictures to obtain a second fused group of pictures, and the second fused group of pictures is input to the twelfth convolutional layer for feature extraction to obtain a second fused feature map, to fuse more feature map information, where the convolutional kernel of the twelfth convolutional layer is 3*3, and the extracted feature number is 16; the second fused feature map is fused with the fourth group of pictures and input to the thirteenth convolutional layer for feature extraction to obtain a third fused feature map, to fuse more feature map information, where the convolution kernel of the thirteenth convolutional layer is 3*3, and the extracted feature number is 16.

The first fused feature map, the second fused feature map, and the third fused feature map are input to the splicing layer for splicing; the fourteenth convolutional layer is used to transform the output of the splicing layer, where the convolution kernel of the fourteenth convolutional layer is 1*1 and the extracted feature number is 64; the second attention layer is used to assign weights to the first fused feature map, the second fused feature map, and the third fused feature map, the first fused feature map, the second fused feature map, and the third fused feature map are weighted and fused, and the fused feature map is fused with the input of the current fourth residual layer (the low-level feature picture/the feature map output from preceding residual layer). It can be seen that the fourth residual layer introduces multiple branches, thereby extending the perceptual field of the residual layer and further improving the performance of the super-resolution reconstruction network in order to facilitate the realization of a good super-resolution reconstruction effect. The second attention layer may be shown in FIG. 18, and the specific way of assigning weights will not be described herein.

In alternative embodiments (not shown), feature extraction is performed on the input feature maps output from the low-level feature picture/current residual layer; and the feature maps are divided into four groups, for example, a first group of pictures, a second group of pictures, a third group of pictures, and a fourth group of pictures; the first group of pictures and the second group of pictures are fused to generate a fourth fused group of pictures, and feature extraction is performed on the fourth fused group of pictures to obtain a fourth fused feature map; the third group of pictures and the fourth group of pictures are fused to generate a fifth fused group of pictures, and feature extraction is performed on the fifth fused group of pictures to obtain a fifth fused feature map; feature extraction is performed on the fourth fused feature map and the fifth fused feature map to obtain a sixth fused feature map, the fourth fused feature map, the fifth fused feature map, and the sixth fused feature map are weighted and fused, and the weighted fused feature map is fused with the feature map output from the low-level feature picture/current residual layer.

It can be seen that the attention layer design is utilized in the picture reconstruction method of the present disclosure, which can effectively improve the performance of the super-resolution reconstruction network and further improve the performance of the super-resolution reconstruction network by using edge information as input. The convolutional neural network and/or a priori filter may be combined in the global residual connection branch to effectively reduce the training difficulty of the network and make the network parameters sparse. Moreover, the introduction of the seventh convolutional layer and the anti-convolutional layer for up-and down-sampling in the residual layer enables the residual layer to extract features at different scales; and/or, the introduction of a multi-branch residual layer to effectively extend the perceptual field of the residual layer by combining the feature maps of different branches.

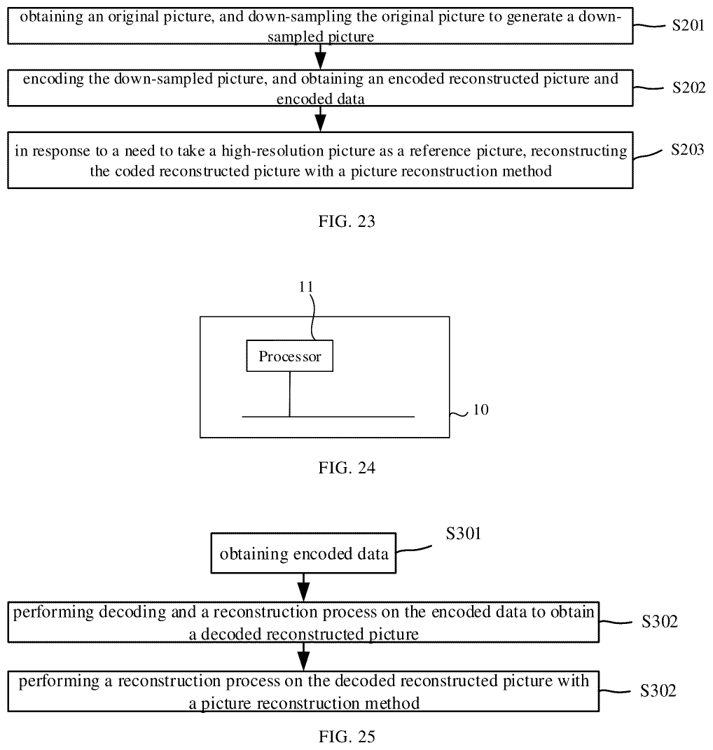

Referring to FIG. 23, FIG. 23 is a flowchart of a picture encoding method according to an embodiment of the present disclosure. It is to be noted that the picture encoding method illustrated in the embodiments is not limited to the following steps.

At block S201: obtaining an original picture, and down-sampling the original picture to generate a down-sampled picture.

In the embodiments, the original picture is a picture contained in an input video sequence, and the input video sequence is a video sequence to be encoded for processing.

At block S202: encoding the down-sampled picture, and obtaining an encoded reconstructed picture and encoded data.

In the embodiments, the encoded reconstructed picture and the encoded data may be generated based on the down-sampled picture, and the encoded data is configured to be transmitted to a decoder for decoding processing.

At block S203: in response to a need to take a high-resolution picture as a reference picture, reconstructing the encoded reconstructed picture with a picture reconstruction method.

In the embodiments, the specific implementation of the picture reconstruction method for reconstruction processing is described in detail above and will not be repeated herein. The output picture is obtained by a reconstruction process with the picture reconstruction method, and the obtained output picture may be taken as a reference picture for the encoded reconstructed picture of the same resolution in the encoding process.

In some embodiments, the encoded reconstructed picture may be taken as an input picture for super-resolution reconstruction, or, the encoded reconstructed picture and the edge information may be taken as the input picture for super-resolution reconstruction.

Referring to FIG. 24, FIG. 24 is a structural schematic view of an encoder according to an embodiment of the present disclosure.

In the embodiment, the encoder 10 includes a memory and a processor 11, with the memory (not shown) configured to store a computer program required for the operation of the processor 11.

The processor 11 may also be referred to as a central processing unit (CPU). The processor 11 may be an integrated circuit chip with signal processing capabilities. The processor 11 may be a general-purpose processor, a digital signal processor (DSP), an application specific integrated circuit (ASIC), a field programmable gate array (FPGA) or other programmable logic device, a discrete gate or transistor logic device, or a discrete hardware component. The general-purpose processor may be a microprocessor or the processor 11 may be any conventional processor, etc.

The processor 11 is configured to execute the computer program to implement a picture reconstruction method as set forth in any of the above embodiments, or a picture encoding method as set forth in the above embodiments.

Referring to FIG. 25, FIG. 25 is a flowchart of a picture decoding method according to an embodiment of the present disclosure. It should be noted that the picture decoding method illustrated in the embodiments is not limited to the following steps.

At block S301: obtaining encoded data.

In the embodiments, the obtained encoded data may be generated with the picture encoding method described above. For example, the encoded data may be generated based on the down-sampled picture in step S202 of the above embodiments.

At block S302: performing decoding and a reconstruction process on the encoded data to obtain a decoded reconstructed picture.

At block S303: performing a reconstruction process on the decoded reconstructed picture with a picture reconstruction method.

In the embodiments, the specific implementation of the picture reconstruction method for reconstruction processing is described in detail above and will not be repeated herein.

In some embodiments, the decoded reconstructed picture may be taken as an input picture for super-resolution reconstruction, or, the decoded reconstructed picture and the edge information may be taken as the input picture for super-resolution reconstruction.

The super-resolution reconstruction network provided by the present disclosure may serve as an up-sampling module, that is, it may be used as an alternative to the up-sampling module in the codec process or as a candidate for the up-sampling module.

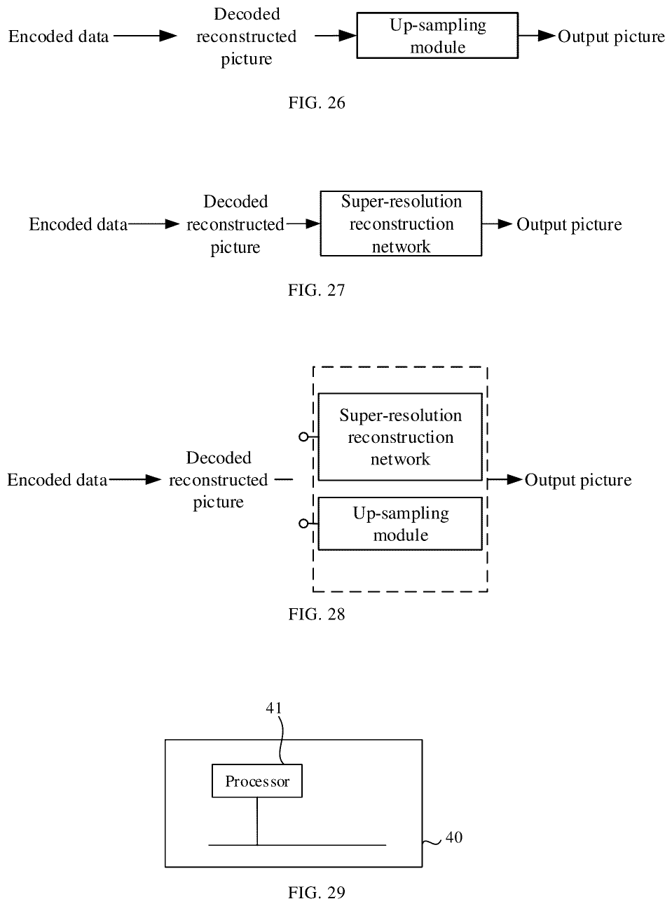

Taking the picture reconstruction method applied to the picture decoding method as an example, referring to FIG. 26 to FIG. 28, FIG. 26 is a flowchart of a picture decoding method in the related art, FIG. 27 is a flowchart of a picture decoding method according to another embodiment of the present disclosure, and FIG. 28 is a flowchart of a picture decoding method according to further another embodiment of the present disclosure.

In the related art, up-sampling is usually performed directly through an up-sampling module to achieve super-resolution reconstruction. As shown in FIG. 27, the decoded reconstructed picture obtained after decoding the encoded data may be input into the super-resolution reconstruction network of the present disclosure, and the output picture may be obtained by reconstruction processing with the picture reconstruction method described in the above embodiments.

Alternatively, as shown in FIG. 28, the output picture may be reconstructed either by the up-sampling module for super-resolution reconstruction or by the picture reconstruction method described in the above embodiments.

In some embodiments, during codec process, when the up-sampling module is replaced by the super-resolution reconstruction network, no syntactic element is required to be transmitted. When the proposed super-resolution reconstruction network is a candidate for the up-sampling module, an additional syntactic element is required to be transmitted to indicate the selection of the way to perform up-sampling; for example, a syntactic element SR_CNN_FLAG may be defined, and its value can be 0 or 1. A value of 0 for SR_CNN_FLAG indicates that the reconstruction process is not performed with the super-resolution reconstruction method proposed by the present disclosure, and a value of 1 indicates that the reconstruction process is performed with the super-resolution reconstruction method proposed by the present disclosure.

Referring to FIG. 29, FIG. 29 is a structural schematic view of a decoder according to an embodiment of the present disclosure.

In some embodiments, the decoder 40 includes a memory and a processor 41, with the memory (not shown) configured to store a computer program required for the operation of the processor 21.

The processor 41 may also be referred to as a central processing unit (CPU). The processor 21 may be an integrated circuit chip with signal processing capabilities. The processor 41 may be a general-purpose processor, a digital signal processor (DSP), an application specific integrated circuit (ASIC), a field programmable gate array (FPGA) or other programmable logic device, a discrete gate or transistor logic device, or a discrete hardware component. The general-purpose processor may be a microprocessor or the processor 41 may be any conventional processor, etc.

The processor 41 is configured to execute the computer program to implement a picture reconstruction method as set forth in any of the above embodiments, or a picture decoding method as set forth in the above embodiments.

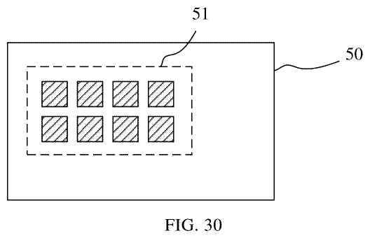

Referring to FIG. 30, FIG. 30 is a structural schematic view of a computer-readable storage medium according to an embodiment of the present disclosure.

In some embodiments, the computer-readable storage medium 50 is configured to store instructions/program data 51, and the instructions/program data 51 are capable of being executed to implement a picture reconstruction method as set forth in any of the above embodiments, or a picture encoding method as set forth in the above embodiments, or a picture decoding method as set forth in the above embodiments, which will not be repeated herein.

In the embodiments provided by the present disclosure, it should be understood that the disclosed systems, devices and methods, may be implemented in other ways. For example, the embodiments of the devices described above are schematic. For example, the division of modules or units, as a logical functional division, may be divided in another way when actually implemented, for example multiple units or components may be combined or may be integrated into another system, or some features may be ignored, or not implemented. On another point, the mutual coupling or direct coupling or communication connection shown or discussed may be an indirect coupling or communication connection through some interface, device, or unit, which may be electrical, mechanical or other forms.

The units illustrated as separate components may or may not be physically separated, and the components displayed as units may or may not be physical units, i.e., they may be located in one place, or they may be distributed to multiple network units. Some or all of these units may be selected according to practical needs to achieve the purpose of this implementation.

In addition, each functional unit in each embodiment of the present disclosure may be integrated in a processing unit, or each unit may be physically present separately, or two or more units may be integrated in a single unit. The above integrated units may be implemented either in the form of hardware or in the form of software functional units.

The above integrated unit, when implemented as a software functional unit and sold or used as a separate product, may be stored in a computer-readable storage medium. Based on this understanding, the technical solution of the present disclosure essentially or the part that contributes to the related art or all or part of this technical solution may be embodied in the form of a software product, stored in a computer-readable storage medium 30 including multiple instructions to enable a computer device (which may be a personal computer, a server, or a network device, etc.) or processor to perform all or some of the steps of the method described in the various embodiments of the present disclosure. The computer-readable storage medium 30 includes: USB flash drive, removable hard disk, read-only memory (ROM), random access memory (RAM), disk or CD-ROM, server, and various other media that may store program code.

In addition, in the present disclosure, unless otherwise expressly specified and limited, the terms “connected”, “coupled”, “laminated”, etc. are to be understood in a broad sense, for example, as fixed connections, removable connections, or in one piece; as direct connections or indirect connections through an intermediate medium, as connections within two elements or as interactions between two elements. To those skilled in the art, the specific meaning of the above terms in the context of the present disclosure may be understood on a case-by-case basis.

Finally, it should be noted that the above embodiments are only intended to illustrate the technical solutions of the present disclosure, not to limit them; although the present disclosure is described in detail with reference to the preceding embodiments, it should be understood by those skilled in the art that it is still possible to modify the technical solutions recorded in the preceding embodiments, or to replace some or all of the technical features therein; and these modifications or replacements does not make the essence of the corresponding technical solutions out of the scope of the technical solutions of the embodiments of the present disclosure.

What is claimed is:

1. A video processing method, comprising:
obtaining a to-be-processed video sequence;
resampling at least one picture of the to-be-processed video sequence, and encoding the at least one picture based on a quantization parameter after resampling; wherein the quantization parameter after resampling is obtained by offsetting a quantization parameter before resampling based on an offset value of quantization parameters of the to-be-processed video sequence, and each resampled picture is encoded to obtain an encoded picture; and
performing a picture resolution reconstruction on the encoded picture as an input picture to generate an output picture; wherein the output picture has a resolution higher than a resolution of the input picture.

2. The method according to claim 1, wherein the to-be-processed video sequence comprises at least one representative picture; the resampling at least one picture of the to-be-processed video sequence, and encoding the at least one picture based on quantization parameters after resampling comprises:
obtaining the offset value of quantization parameters of the to-be-processed video sequence; wherein the offset value of quantization parameters cause that a first constraint relationship is satisfied between a rate-quantization balance cost of each representative picture before resampling and a rate-quantization balance cost of the representative picture after resampling; the rate-quantization balance cost before resampling is obtained by fusing a rate and a quantization parameter before resampling, and the rate-quantization balance cost after resampling is obtained by fusing a desired rate and a quantization parameter after resampling;
obtaining the quantization parameter after resampling by offsetting the quantization parameter before resampling based on the offset value of quantization parameters;
resampling the at least one picture in the to-be-processed video sequence; and
encoding the at least one picture based on the quantization parameter after resampling.

3. The method according to claim 2, wherein the obtaining the offset value of quantization parameters of the to-be-processed video sequence comprises:
determining the desired rate after resampling based on the rate before resampling and a second constraint relationship between the rate before resampling and the desired rate after resampling; and
calculating the offset value of quantization parameters based on the rate and quantization parameter before resampling, the desired rate after resampling, and the first constraint relationship.

4. The method according to claim 3, wherein a first functional relationship exists between the rate-quantization balance cost before resampling and the rate and quantization parameter before resampling, and a second functional relationship exists between the rate-quantization balance cost after resampling and the desired rate and quantization parameter after resampling; a third functional relationship exists between the rate and quantization parameter before resampling, and a fourth functional relationship exists between the desired rate and quantization parameter after resampling;
the calculating the offset value of quantization parameters based on the rate and quantization parameter before resampling, the desired rate after resampling, and the first constraint relationship comprises:
calculating the first coefficient of the first functional relationship based on the third functional relationship, and calculating the second coefficient of the second functional relationship based on the fourth functional relationship; and
calculating the offset value of quantization parameters based on the first coefficient, the second coefficient, the rate and quantization parameter before resampling, the desired rate after resampling, and the first constraint relationship;
in the first functional relationship, the rate-quantization balance cost before resampling is a linear summation between the rate before resampling multiplied by the first coefficient and the quantization parameter before resampling; in the second functional relationship, the rate-quantization balance cost after resampling is a linear summation between the desired rate after resampling multiplied by the second coefficient and the quantization parameter after resampling;
the calculating the first coefficient of the first functional relationship based on the third functional relationship, and calculating the second coefficient of the second functional relationship based on the fourth functional relationship comprise:
taking an absolute value of a partial derivative of the third functional relationship at the rate before resampling as the first coefficient, and taking an absolute value of a partial derivative of the fourth functional relationship at the desired rate after resampling as the second coefficient;
in the third functional relationship, the quantization parameter before resampling is a power function of the rate before resampling, and in the fourth functional relationship, the quantization parameter after resampling is a power function of the desired rate after resampling; or
the desired rate after resampling is a range;
the calculating the offset value of quantization parameters based on the rate and quantization parameter before resampling, the desired rate after resampling, and the first constraint relationship comprises:
determining a range of the offset value of quantization parameters based on the range of the desired rate after resampling;
selecting at least two candidate values from the range of the offset value of quantization parameters, obtaining a sum value by performing weighted summation on the at least two candidate values, and taking the sum value as the offset value of quantization parameters; or
the first constraint relationship is that a proportional relationship is satisfied between the rate-quantization balance cost before resampling and the rate-quantization balance cost after resampling; the second constraint relationship is that a proportional range is satisfied between the rate before resampling and the desired rate after resampling.

5. The method according to claim 2, before the obtaining the offset value of quantization parameters of the to-be-processed video sequence, further comprising:
performing a resampling decision based on a quality characterization value of the representative picture after resampling at a resampling ratio; and
in response to a result of the resampling decision on the representative picture being to perform resampling, performing the obtaining the offset value of quantization parameters of the to-be-processed video sequence, obtaining the quantization parameter after resampling by offsetting the quantization parameter before resampling based on the offset value of quantization parameters; resampling the at least one picture in the to-be-processed video sequence; and encoding the at least one picture based on the quantization parameter after resampling.

6. The method according to claim 5, wherein the quality characterization value is a rate-distortion balance cost, and the rate-distortion balance cost is obtained from a fusion of an actual rate and a distortion of the representative picture after resampling at the resampling ratio;
the rate-distortion balance cost is a weighted sum of the actual rate and distortion after resampling; or
the resampling ratio is a single value, and the performing a resampling decision based on a quality characterization value of the representative picture after resampling at a resampling ratio comprises:
determining whether the quality characterization value corresponding to the resampling ratio is less than a characterization threshold; and in response to the quality characterization value corresponding to the single resampling ratio being less than the characterization threshold, the resampling decision is to perform resampling; or
the resampling ratio comprises at least two resampling ratios is at least two, and the performing a resampling decision based on a quality characterization value of the representative picture after resampling at a resampling ratio comprises:
determining whether a minimum value of the quality characterization values corresponding to the at least two resampling ratios is less than the characterization threshold; and in response to the minimum value being less than the characterization threshold, the resampling decision is to perform resampling based on the resampling ratio corresponding to the minimum value.

7. The method according to claim 2, before the resampling the at least one picture in the to-be-processed video sequence, further comprising:
determining a target resampling strategy from a plurality of candidate resampling strategies.
determining each representative picture and a picture for decision whether to be resampled corresponding to the representative picture from the to-be-processed video sequence based on the target resampling strategy; and
performing a resampling decision on the picture for decision whether to be resampled based on a result of the resampling decision of the representative picture; wherein a correspondence between the representative picture and the picture for decision whether to be resampled in different candidate resampling strategies is different;
the plurality of candidate resampling strategies comprises at least two of a frame-level resampling strategy, a group-level resampling strategy, and a sequence-level resampling strategy; under the frame-level resampling strategy, each representative picture and the to-be-resampled decision picture are the same picture; under the group-level resampling strategy, the at least one representative picture comprises at least some of pictures in a group of pictures (GOPs) included in the to-be-processed video sequence, and the picture for decision whether to be resampled comprises all pictures in the GOP to which the representative picture belongs; under the sequence-level resampling strategy, the at least one representative picture comprises pictures in at least some of GOPs included in the to-be-processed video sequence, and the picture for decision whether to be resampled comprises all pictures in the to-be-processed video sequence;
under the group-level resampling strategy, in condition of the number of the at least one representative picture being multiple, the results of the resampling decisions of the pictures for decision whether to be resampled are obtained by voting the results of the resampling decisions of the at least one representative picture; and/or
under the sequence-level resampling strategy, when in condition of the at least one representative picture comprising the pictures in GOPs included in the to-be-processed video sequence, the result of the resampling decision of the to-be-processed video sequence is obtained by voting the results of the resampling decisions of the GOPs to which the at least one representative picture belongs; or
the obtaining the offset value of quantization parameters of the to-be-processed video sequence comprises:
obtaining the offset value of quantization parameters by looking up a table based on a difference characterization value between the rate before resampling and an actual rate after resampling.

8. A video decoding method, comprising:
obtaining a to-be-decoded picture;
decoding the to-be-decoded picture to obtain a decoded picture; and
performing a picture resolution reconstruction on the decoded picture to generate an output picture, wherein the output picture has a resolution higher than a resolution of the decoded picture.

9. The method according to claim 8, wherein the performing a picture resolution reconstruction on the decoded picture to generate an output picture comprises:
inputting the input picture into a global residual connection branch and a residual neural network branch of a super-resolution reconstruction network, respectively, to up-sample the input picture with the global residual connection branch for obtaining base information of the input picture, and to reconstruct the input picture with the residual neural network branch for obtaining residual information of the input picture; and
fusing the base information and the residual information to generate the output picture.

10. The method according to claim 9, wherein the up-sampling the input picture with the global residual connection branch for obtaining base information of the input picture comprises:
up-sampling the input picture with at least one up-sampling processing module, respectively, to obtain sub-basic information corresponding to each up-sampling processing module; wherein each at least one up-sampling processing module comprises at least one type of a convolutional neural network and an a priori filter;
obtaining basic information for fusion with the residual information based on the sub-basic information corresponding to each up-sampling processing module.

11. The method according to claim 10, wherein the sub-basic information corresponding to each up-sampling processing module comprises first sub-basic information corresponding to the convolutional neural network, and second sub-basic information corresponding to the a priori filter; the obtaining basic information for fusion with the residual information based on the sub-basic information corresponding to each up-sampling processing module comprises:
weighted fusing the first sub-basic information and the second sub-basic information to obtain the basic information.

12. The method according to claim 11, wherein each up-sampling processing module comprises the convolutional neural network, and the convolutional neural network comprises a feature extraction layer, a first convolutional layer, and a subordination layer that are sequentially cascaded; the convolutional neural network performing up-sampling on the input picture to obtain the first sub-basic information comprises:
extracting features of the input picture with the feature extraction layer;
taking an output of the feature extraction layer as an input of the first convolutional layer to obtain feature maps of a plurality of channels; and
fusing the feature maps of a plurality of channels to obtain the first sub-basic information with the subordination layer; or
the global residual connection branch comprises a first attention layer, and the first attention layer comprises a second convolutional layer, a global average pooling layer, a third convolutional layer, a first activation layer, a fourth convolutional layer, and a normalization layer that are sequentially cascaded;
wherein the weighted fusing the first sub-basic information and the second sub-basic information to obtain the basic information comprises:
fusing the first sub-basic information and the second sub-basic information to generate fused information, and inputting the fused information into the second convolutional layer for feature extraction;
performing global average pooling on an output of the second convolutional layer with the global average pooling layer;
performing feature extraction on an output of the global average pooling layer with the third convolutional layer;
taking an output of the third convolutional layer as an input of the first activation layer, performing activation processing with the first activation layer, and inputting an activated feature map to the fourth convolutional layer for feature extraction;
performing normalization activation on an output of the fourth convolutional layer with the normalization layer to obtain weights corresponding to the first sub-basic information and the second sub-basic information; and
performing weighted fusion on the first sub-basic information and the second sub-basic information with the weights.

13. The method according to claim 11, wherein each up-sampling processing module comprises the a priori filter, and the a priori filter comprises a resampling filter; the a priori filter performing up-sampling on the input picture comprises:
performing up-sampling interpolation filtering on the input picture with the resampling filter.

14. The method according to claim 13, wherein the input picture comprises a luminance component and a chrominance component, and a tap coefficient corresponding to the luminance component is greater than a tap coefficient corresponding to the chrominance component; or
before the performing up-sampling interpolation filtering on the input picture with the resampling filter, further comprising:
assigning filter coefficients in a row direction of the resampling filter in combination with a coordinate value of a current pixel in the output picture, a width of the input picture, and a width of the output picture; and
assigning filter coefficients in a column direction of the resampling filter in combination with the coordinate value of the current pixel in the output picture, a height of the input picture, and a height of the output picture;
the input picture comprises a luminance component and a chrominance component;
filter coefficients in a row direction are defined as:
frac=((x*orgWidth<<4)/scaledWidth)&numFracPositions;
filter coefficients in a column direction are defined as:
frac=((y*orgHeight<<4)/scaledHeight)&numFracPositions;
where (x, y) indicates coordinates of the current pixel in the output picture; orgWidth indicates the width of the input picture, scaledWidth indicates the width of the output picture, orgHeight indicates the height of the input picture, and scaledHeight indicates the height of the output picture; a value of numFracPositions is a first preset value when calculating the filter coefficients of the luminance component, and a value of numFracPositions is a second preset value when calculating the filter coefficients of the chrominance component; or
the performing up-sampling interpolation filtering on the input picture with the resampling filter comprises:
applying 16 arrays of 8-tap filter coefficients for up-sampling interpolation filtering a luminance component of the input picture, and applying 32 arrays of 4-tap filter coefficients for up-sampling interpolation filtering a chrominance component of the input picture.

15. The method according to claim 11, wherein each up-sampling processing module comprises the a priori filter, and the a priori filter comprises a bilinear cubic interpolation filter; the a priori filter performing up-sampling on the input picture comprises:
performing up-sampling interpolation filtering on the input picture with the bilinear cubic interpolation filter;
the performing up-sampling interpolation filtering on the input picture with the bilinear cubic interpolation filter comprises:
obtaining 4*4 neighborhood points within a preset range of a to-be-interpolated pixel point, and obtaining a pixel value of the to-be-interpolated pixel point with coordinates of the neighborhood points; and
combining the pixel value of the to-be-interpolated pixel point and a bilinear cubic interpolation function to perform up-sampling interpolation filtering on the input picture;
the obtaining a pixel value of the to-be-interpolated pixel point with coordinate values of the neighborhood points comprises:
the pixel value of the to-be-interpolated pixel point is defined as:
$$f ( x , y ) = {\sum }_{i = 0}^{3} {\sum }_{j = 0}^{3} f ( {x}_{i} , {y}_{j} ) \cdot W ( x - {x}_{i} ) \cdot W ( y - {y}_{j} ) ;$$
where (x, y) indicates coordinates of the to-be-interpolated pixel point, (xᵢ, yᵢ) indicates the coordinates of the neighboring point, wherein i=0, 1, 2, 3 and j=0, 1, 2, 3, f(xᵢ, yᵢ) indicates the pixel value of the to-be-interpolated pixel point, and W indicates the bilinear cubic interpolation function;
the bilinear cubic interpolation function is defined as:
$$W ( x ) = \{ \begin{matrix}( a + 2 ) \cdot {\vert x \vert}^{3} - ( a + 3 ) \cdot {\vert x \vert}^{2} + 1 , \vert x \vert \leq 1 \\ ( a ) \cdot {\vert x \vert}^{3} - 5 a \cdot {\vert x \vert}^{2} + 8 a \vert x \vert - 4 a , 1 < \vert x \vert < 2 \\ 0 , \vert x \vert \geq 2\end{matrix} \} ;$$
where a is a third preset value.

16. The method according to claim 9, wherein,
the residual neural network comprises a low-level feature extraction layer, a mapping layer, a high-level feature extraction layer, and an up-sampling layer that are sequentially cascaded; an output of the low-level feature extraction layer is connected to an input of the up-sampling layer to form a local residual connection branch; the mapping layer comprises a plurality of residual layers that are sequentially connected; the reconstructing the input picture with the residual neural network branch for obtaining residual information of the input picture comprises:
mapping the input picture to a feature domain with the low-level feature extraction layer to extract a low-level feature picture of the input picture;
mapping the low-level feature picture into a first high-level feature picture with the mapping layer;
performing feature extraction on the first high-level feature picture with the high-level feature extraction layer to obtain a second high-level feature picture;
fusing the low-level feature picture and the second high-level feature picture with the local residual connection branch to obtain a fused feature picture; and
obtaining the residual information by expanding the dimension of the fused feature picture as well as up-sampling by the up-sampling layer.

17. The method according to claim 16, wherein the residual neural network further comprises an input layer and an output layer; the input layer is connected to the low-level feature extraction layer and the output layer is connected to the up-sampling layer; the method further comprises:
inputting the input picture to the input layer, performing an input transformation process on the input picture, and taking the transformed input picture as an input of the low-level feature extraction layer; wherein a form of the transformed input picture matches a form of an allowed input of the low-level feature extraction layer; and/or
inputting the residual information to the output layer, performing an output transformation process on the residual information, and taking the transformed residual information as an output of the residual neural network branch; or
the mapping layer comprises a plurality of first residual layers that are sequentially connected, and each first residual layer comprises a fifth convolutional layer, a second activation layer, a sixth convolutional layer, and a second attention layer;
the method further comprises:
performing feature extraction on the low-level feature picture or a feature map output from a preceding residual layer with the fifth convolutional layer;
performing activation process on an output of the fifth convolutional layer with the second activation layer, and performing feature extraction on an output of the second activation layer with the sixth convolutional layer to obtain a plurality of mapped feature pictures corresponding to a plurality of channels;
obtaining a weight assigned to each mapped feature picture with the second attention layer;
weighted fusing the plurality of mapped feature pictures to obtain a weighted fused picture, and fusing the weighted fused picture with the low-level feature picture or the feature map output from the preceding residual layer;
the mapping layer further comprises a plurality of second residual layers and a plurality of third residual layers; the plurality of first residual layers, second residual layers, and third residual layers are connected; each second residual layer comprises a seventh convolutional layer spanning greater than one and a first residual layer, and the seventh convolutional layer is connected to the first residual layer to down-sample a feature map input to the second residual layer; each third residual layer comprises an anti-convolutional layer spanning more than one and a first residual layer, and the anti-convolutional layer is connected to the first residual layer to up-sample a feature map input to the third residual layer;
the plurality of first residual layers, with output feature maps being size-matched, are connected to fuse the matched feature maps.

18. The method according to claim 16, further comprising:
performing feature extraction on the low-level feature picture or feature maps output from a preceding residual layer, and dividing the extracted feature maps to obtain a plurality of groups of pictures;
performing a plurality of fusions on the plurality of groups of pictures to obtain a plurality of fused groups of pictures, performing feature extraction on the plurality of fused groups of pictures to obtain a plurality of fused feature maps; and
performing weighted fusion on the plurality of fused feature maps, and fusing the plurality of weighted fused feature maps with the low-level feature picture or the feature maps output from the preceding residual layer;
wherein the mapping layer further comprises a plurality of fourth residual layers that are sequentially cascaded; each fourth residual layer comprises a tenth convolutional layer, a segmentation layer, an eleventh convolutional layer, a twelfth convolutional layer, a thirteenth convolutional layer, a splicing layer, a fourteenth convolutional layer, and a second attention layer;
the performing feature extraction on the low-level feature picture or feature maps output from a preceding residual layer, and dividing the extracted feature maps to obtain a plurality of groups of pictures comprises:
inputting the low-level feature picture or the feature maps output from the preceding residual layer to the tenth convolutional layer for feature extraction;
dividing feature maps output from the tenth convolutional layer into four groups with the segmentation layer, which are a first group of pictures, a second group of pictures, a third group of pictures, and a fourth group of pictures;
fusing the first group of pictures with the second group of pictures to obtain a first fused group of pictures, and performing feature extraction on the first fused group of pictures with the eleventh convolutional layer to obtain a first fused feature map;
fusing an output of the eleventh convolutional layer with the third group of pictures to obtain a second fused group of pictures, and performing feature extraction on the second fused group of pictures with the twelfth convolutional layer to obtain a second fused feature map;
fusing an output of the twelfth convolutional layer with the fourth group of pictures to obtain a third fused group of pictures, and performing feature extraction on the third fused group of pictures with the thirteenth convolutional layer to obtain a third fused feature map;
the performing weighted fusion on the plurality of fused feature maps, and fusing the plurality of weighted fused feature maps with the low-level feature picture comprises:
inputting the first fused feature map, the second fused feature map, and the third fused feature map to the splicing layer for splicing;
performing feature transform on an output of the splicing layer with the fourteenth convolutional layer;
assigning weights to the first fused feature map, the second fused feature map, and the third fused feature map with the second attention layer;
weighted fusing the first fused feature map, the second fused feature map, and the third fused feature map to obtain a fused feature map, and fusing the fused feature map with the low-level feature picture;
the second attention layer comprises a global average pooling layer, an eighth convolutional layer, a third activation layer, a ninth convolutional layer, and a normalization layer that are sequentially cascaded; the method further comprises:
performing global average pooling on the plurality of mapped feature pictures with the global average pooling layer;
performing feature extraction on feature maps processed after the global average pooling;
performing activation on feature maps output from the eighth convolutional layer with the third activation layer, and inputting the activated feature maps into the ninth convolutional layer for feature extraction; and
performing normalized activation processing on an output of the ninth convolutional layer with the normalization layer, to assign a weight to each component of the input picture.

19. The method according to claim 9, wherein the input picture comprises a reconstructed picture and a picture formed with edge information.

20. An electronic device, comprising a processor and a memory connected to the processor;
wherein the memory stores a program instruction;
the processor is configured to execute the program instruction stored in the memory to perform a method comprising:
obtaining a to-be-processed video sequence;
resampling at least one picture of the to-be-processed video sequence, and encoding the at least one picture based on a quantization parameter after resampling; wherein the quantization parameter after resampling is obtained by offsetting a quantization parameter before resampling based on an offset value of quantization parameters of the to-be-processed video sequence, and each resampled picture is encoded to obtain an encoded picture; and
performing a picture resolution reconstruction on the encoded picture as an input picture to generate an output picture; wherein the output picture has a resolution higher than a resolution of the input picture; or
obtaining a to-be-decoded picture;
decoding the to-be-decoded picture to obtain a decoded picture; and
performing a picture resolution reconstruction on the decoded picture to generate an output picture, wherein the output picture has a resolution higher than a resolution of the decoded picture.
